(19) United States
(12) Patent Application Publication
(10) Pub. No.: US 2024/0241356 A1
(43) Pub. Date: Jul. 18, 2024

(54) ZOOM LENS, IMAGE PICKUP APPARATUS, AND IMAGE PICKUP SYSTEM WITH THE SAME

(71) Applicant: CANON KABUSHIKI KAISHA, Tokyo (JP)

(72) Inventor: Shinichiro SAITO, Tochigi (JP)

(21) Appl. No.: 18/544,530

(22) Filed: Dec. 19, 2023

(30) Foreign Application Priority Data
Jan. 17, 2023 (JP) 2023-005206

(51) Int. Cl. G02B 15/14; G02B 13/00; G02B 13/02

(52) U.S. Cl. CPC G02B 15/1461; G02B 13/0045; G02B 13/02

(57) ABSTRACT

A zoom lens includes, in order from an object side to an image side, a first lens unit having a positive refractive power, a front group including one or two lens unit and having a negative refractive power as a whole, and a rear group including an aperture stop and one or more lens unit. Each distance between adjacent lens units changes during zooming. The first lens unit is fixed relative to an image plane during focusing. The first lens unit includes a positive lens disposed closest to an object. At least four lens units move during zooming from a wide-angle end to a telephoto end. At the telephoto end, a combined refractive power from the positive lens to a lens disposed closest to an image in the front group is negative. A predetermined inequality is satisfied.

### BACKGROUND

### Technical Field

One of the aspects of the embodiments relates to a zoom lens, which is suitable for a digital video camera, a digital still camera, a broadcast camera, a silver halide film camera, a surveillance camera, and the like.

### Description of Related Art

In recent years, there has been a demand for a telephoto lens that has a zoom function, is small in size and has a large aperture, and yet has high optical performance. Japanese Patent Laid-Open No. 2019-120746 discloses an optical system with a plurality of converter lenses, the optical system consisting of first to third lens units of positive, negative, and positive refractive powers and a subsequent unit including one or more lens units, which are arranged in order from an object side to an image side, in order to reduce weight and increase telephoto performance. Japanese Patent Laid-Open No. 2022-26392 discloses an optical system which has a first lens unit of a positive refractive power, a second lens unit of a negative refractive power, and a subsequent unit including one or more lens units, which are arranged in order from an object side to an image side, the first lens unit being composed of a plurality of subunits, in order to achieve both compact size and light weight and high image quality. International Publication No. 2022/124184 discloses an optical system that has a first lens unit of a positive refractive power, a second lens unit, and a subsequent unit including one or more lens units, which are arranged in order from an object side to an image side, an air interval being ensured in the first lens unit, in order to both improve optical performance and reduce weight.

However, in the optical system described in Japanese Patent Laid-Open No. 2019-120746, it is possible to achieve a telephoto lens with the plurality of converter lenses while optimizing the refractive power of the first and second lens units to achieve miniaturization, but it is difficult to achieve miniaturization when an image sensor becomes large. In the optical system described in Japanese Patent Laid-Open No. 2022-26392, it is possible to improve image quality by changing an interval of a main variable magnification unit during zooming or increasing the number of lenses constituting the main variable magnification unit, but it is difficult to achieve a large aperture. In the optical system described in International Publication No. 2022/124184, a configuration of each lens unit is optimized to achieve both weight reduction and suppression of chromatic aberration, but if an aperture is increased, it is difficult to achieve miniaturization.

### SUMMARY

A zoom lens according to one aspect of the embodiment includes, in order from an object side to an image side, a first lens unit having a positive refractive power, a front group including one or two lens unit and having a negative refractive power as a whole, and a rear group including an aperture stop and one or more lens unit. Each distance between adjacent lens units changes during zooming. The first lens unit is fixed relative to an image plane during focusing. The first lens unit includes a positive lens disposed closest to an object. At least four lens units move during zooming from a wide-angle end to a telephoto end. At the telephoto end, a combined refractive power from the positive lens to a lens disposed closest to an image in the front group is negative. The following inequalities are satisfied:

$$0.10 < dsw / Ldw < 0.50 ,$$

$$1.45 < nd 1 max \leq 1.8 ,$$

$$and$$

$$3 < d 1 a / dUa < 300 ,$$

where dsw is a distance on an optical axis from the aperture stop to the image plane at the wide-angle end, Ldw is a total length of the zoom lens at the wide-angle end, ndlmax is a maximum refractive index of lenses included in the first lens unit, d1a is a maximum value of air intervals in the first lens unit in an entire zoom range, and dUa is a maximum value of air intervals in the front group in the entire zoom range.

An image pickup apparatus having the above zoom lens also constitutes another aspect of the embodiment.

Further features of the disclosure will become apparent from the following description of embodiments with reference to the attached drawings.

### BRIEF DESCRIPTION OF THE DRAWINGS

FIG. 1 is cross-sectional views of a zoom lens according to Example 1 at a wide-angle end, an intermediate zoom position, and a telephoto end.

FIGS. 2A, 2B, and 2C are aberration diagrams of the zoom lens according to Example 1 at the wide-angle end, the intermediate zoom position, and the telephoto end, respectively.

FIG. 3 is cross-sectional views of a zoom lens according to Example 2 at a wide-angle end, an intermediate zoom position, and a telephoto end.

FIGS. 4A, 4B, and 4C are aberration diagrams of the zoom lens according to Example 2 at the wide-angle end, the intermediate zoom position, and the telephoto end, respectively.

FIG. 5 is cross-sectional views of a zoom lens according to Example 3 at a wide-angle end, an intermediate zoom position, and a telephoto end.

FIGS. 6A, 6B, and 6C are aberration diagrams of the zoom lens according to Example 3 at the wide-angle end, the intermediate zoom position, and the telephoto end, respectively.

FIG. 7 is cross-sectional views of a zoom lens according to Example 4 at a wide-angle end, an intermediate zoom position, and a telephoto end.

FIGS. 8A, 8B, and 8C are aberration diagrams of the zoom lens according to Example 4 at the wide-angle end, the intermediate zoom position, and the telephoto end, respectively.

FIG. 9 is cross-sectional views of a zoom lens according to Example 5 at a wide-angle end, an intermediate zoom position, and a telephoto end.

FIGS. 10A, 10B, and 10C are aberration diagrams of the zoom lens according to Example 5 at the wide-angle end, the intermediate zoom position, and the telephoto end, respectively.

FIG. 11 is cross-sectional views of a zoom lens according to Example 6 at a wide-angle end, an intermediate zoom position, and a telephoto end.

FIGS. 12A, 12B, and 12C are aberration diagrams of the zoom lens according to Example 6 at the wide-angle end, the intermediate zoom position, and the telephoto end, respectively.

FIG. 13 is a schematic diagram of an image pickup apparatus.

### DESCRIPTION OF THE EMBODIMENTS

Referring now to the accompanying drawings, a detailed description will be given of embodiments according to the disclosure. Corresponding elements in respective figures will be designated by the same reference numerals, and a duplicate description thereof will be omitted.

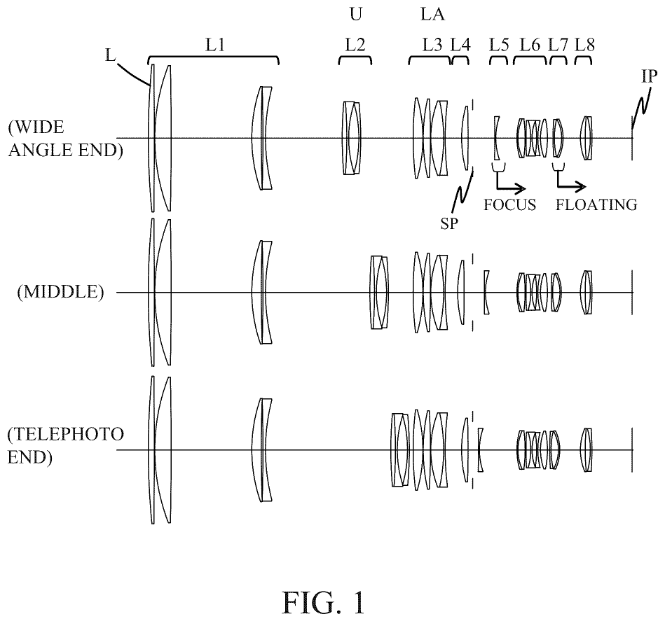

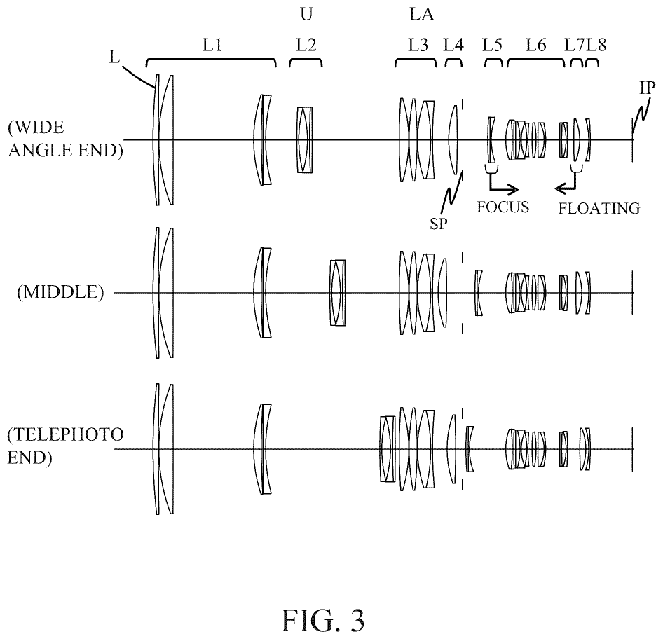

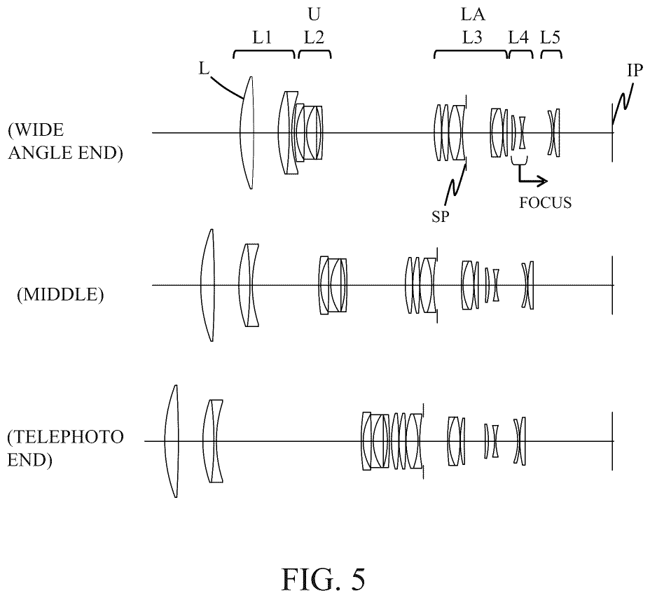

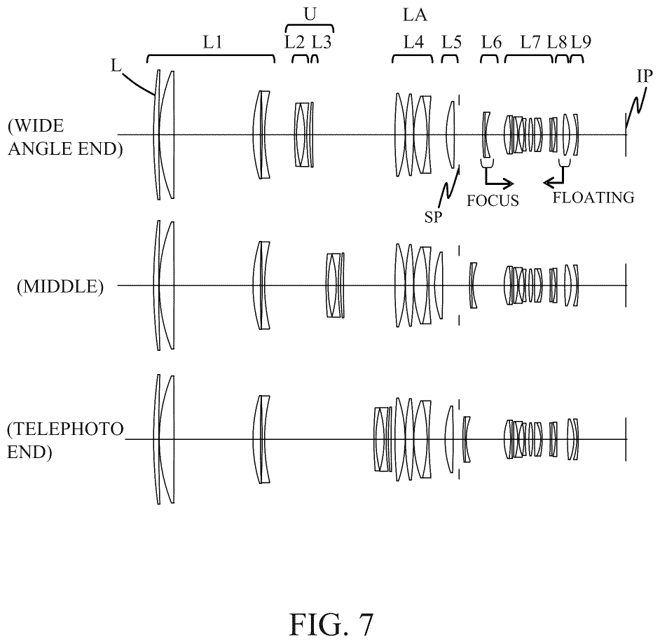

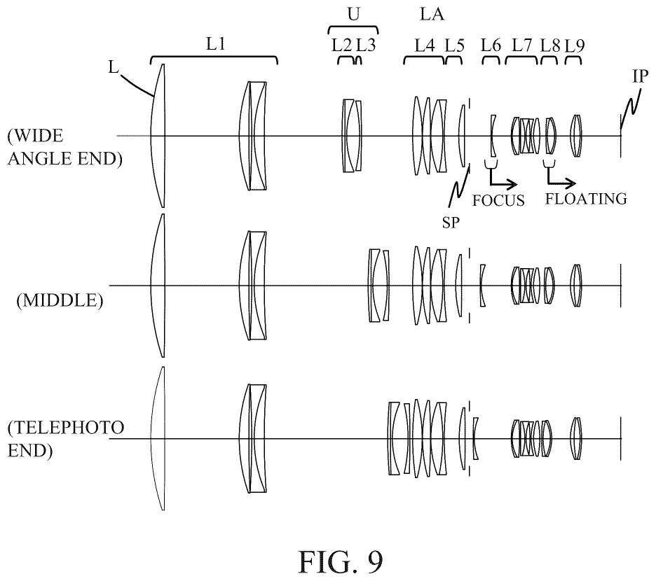

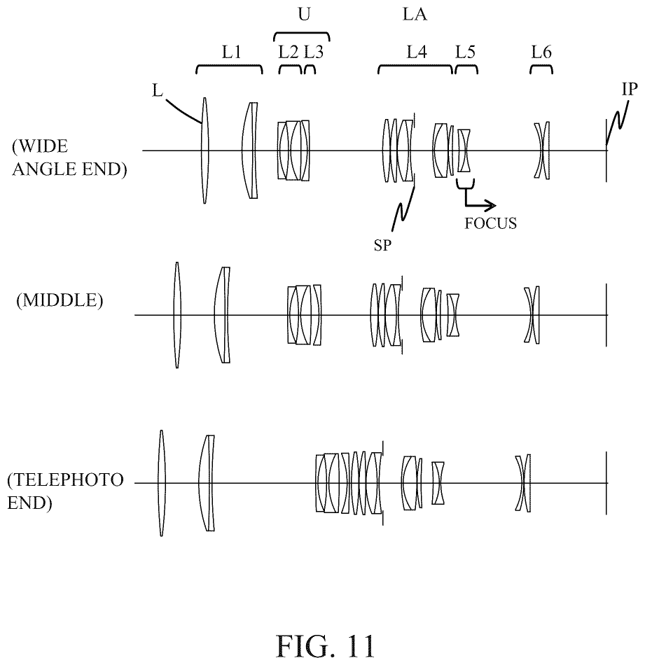

FIGS. 1, 3, 5, 7, 9, and 11 are cross-sectional views of zoom lenses according to Examples 1 to 6 at a wide-angle end (short focal length end), an intermediate zoom position, and a telephoto end (long focal length end), respectively. The zoom lens according to each example is used in an optical apparatus including an image pickup apparatus such as a digital video camera, a digital still camera, a broadcast camera, a silver halide film camera, and a surveillance camera, and an interchangeable lens. The zoom lens according to each example can also be used as a projection optical system for a projection apparatus (projector).

In each cross-sectional view, a left side is an object side and a right side is an image side. The zoom lens according to each example is configured to include a plurality of lens units. In this specification, a lens unit is a unit of lenses that move together or remain stationary during zooming. In other words, in the zoom lens according to each example, each distance between adjacent lens units changes during zooming. The lens unit may consist of a single lens or a plurality of lenses. The lens unit may also include an aperture stop.

In each cross-sectional view, Li represents an i-th lens unit (i is a natural number) counted from the object side among the lens units included in the zoom lens.

Further, SP represents an aperture stop that determines (restricts) luminous flux of an open F number (Fno). IP represents an image plane, and when the zoom lens according to each example is used as an image pickup optical system of a video camera or a digital still camera, an image pickup plane of a solid-state image sensor (photoelectric conversion element) such as a CCD sensor or a CMOS sensor is placed on the image plane IP. Furthermore, when the zoom lens according to each example is used as an image pickup optical system of a silver halide film camera, a photosensitive surface corresponding to a film surface is placed on the image plane IP.

Arrows related to Focus and Floating indicate a direction of movement of a lens unit when focusing from infinity to a short distance.

A protective glass may be disposed on the object side of a first lens unit L1 to protect lenses. Furthermore, a protective glass or a low-pass filter may be disposed between the lens disposed closest to the image in the zoom lens and the image plane IP. An optical member with an extremely weak refractive power, such as the protective glass and the low-pass filter, is not treated as a lens constituting the zoom lens. The optical member with the extremely weak refractive power is an optical member whose absolute value of focal length is three times or more than a focal length of the zoom lens.

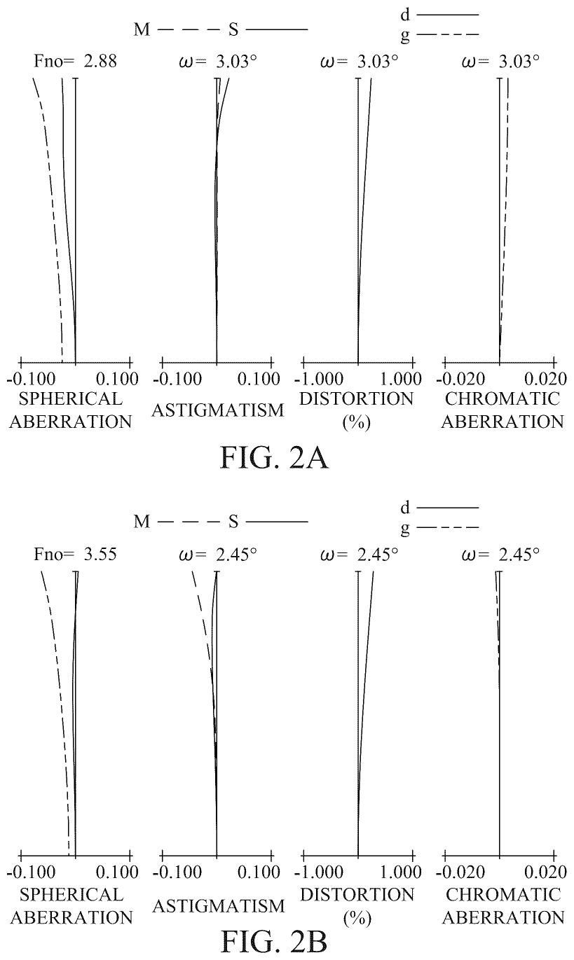

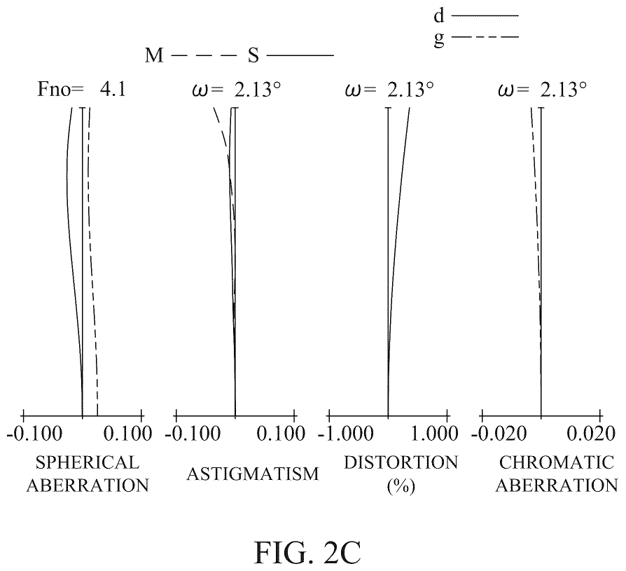

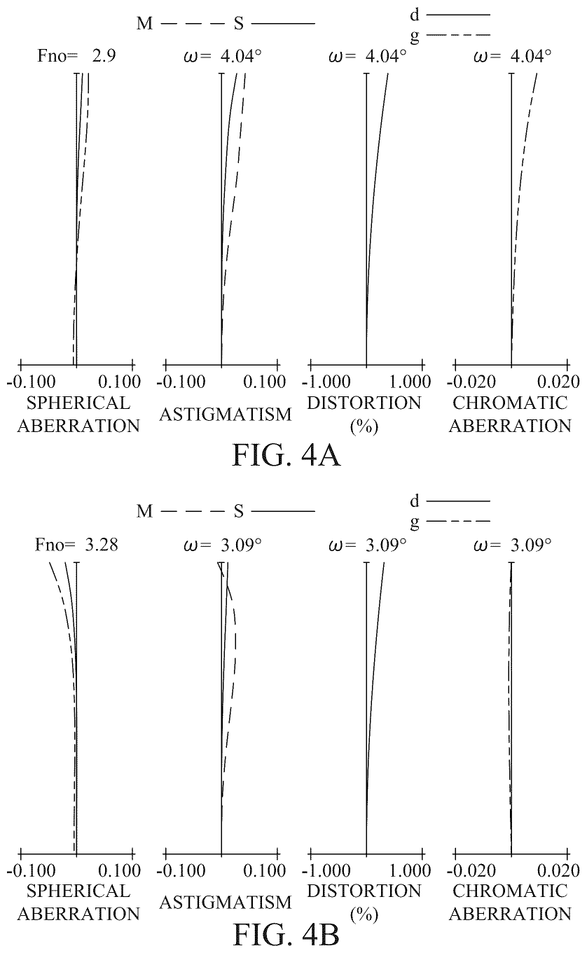

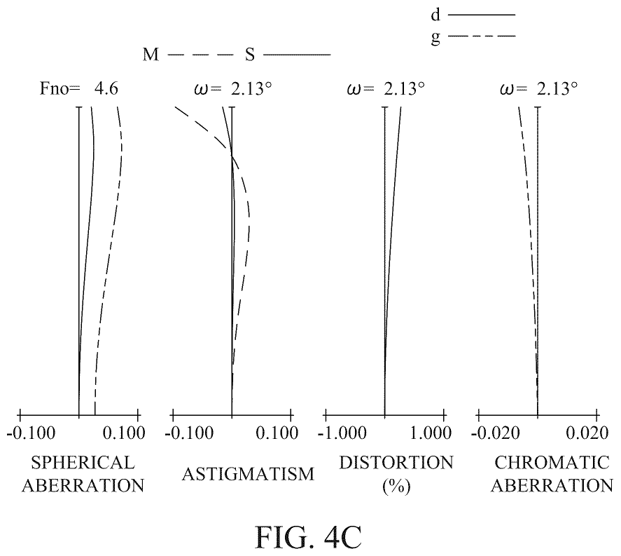

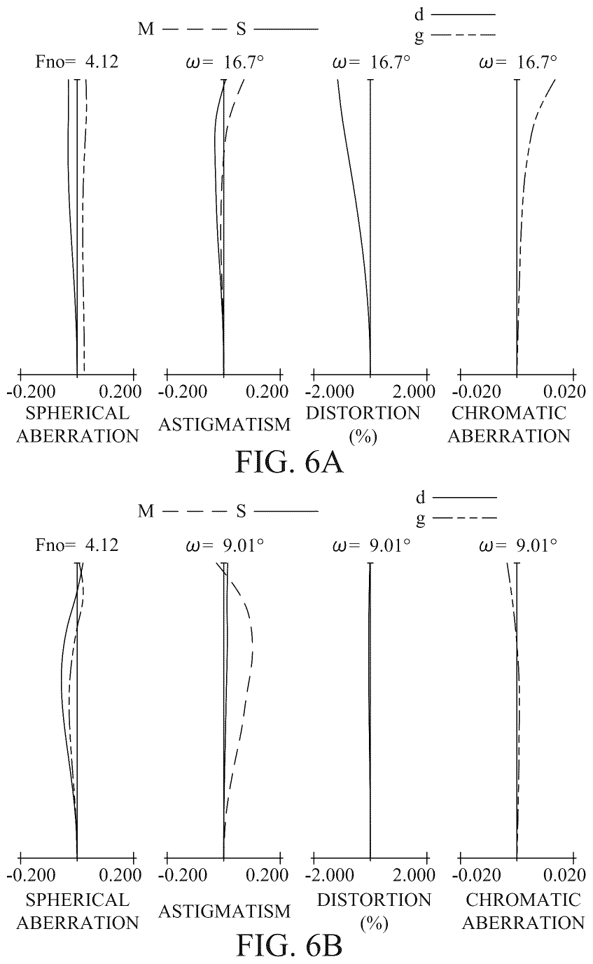

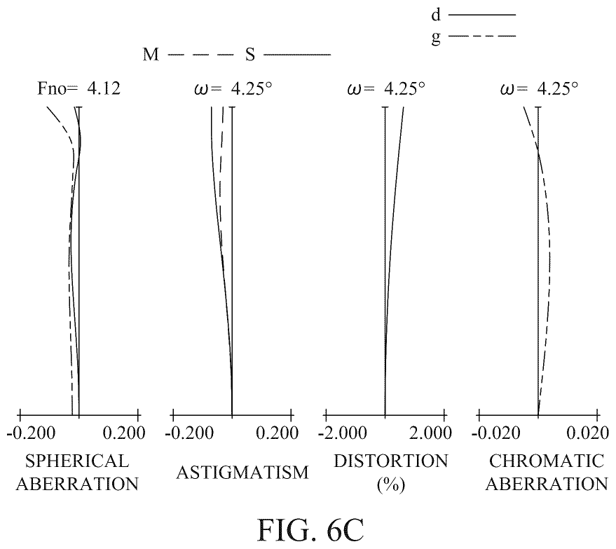

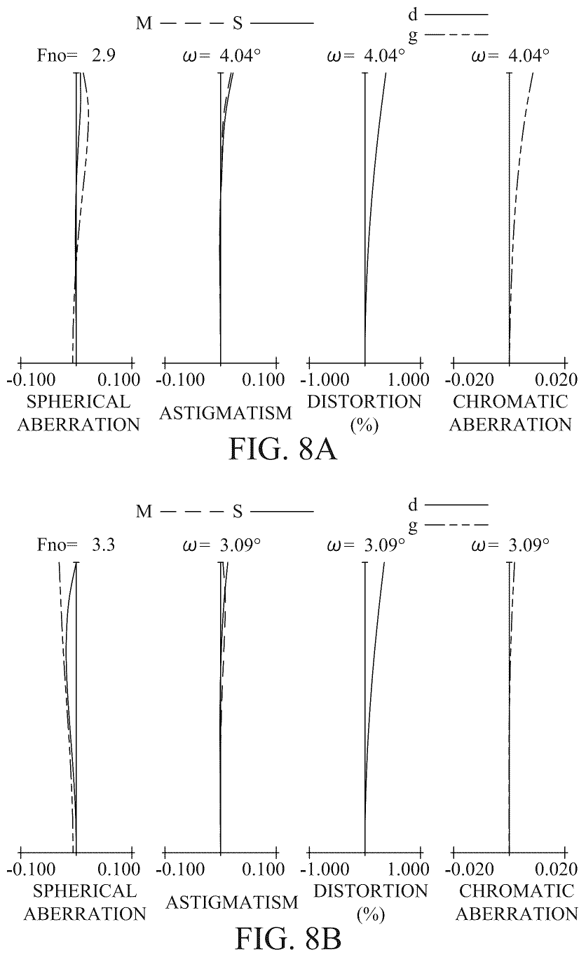

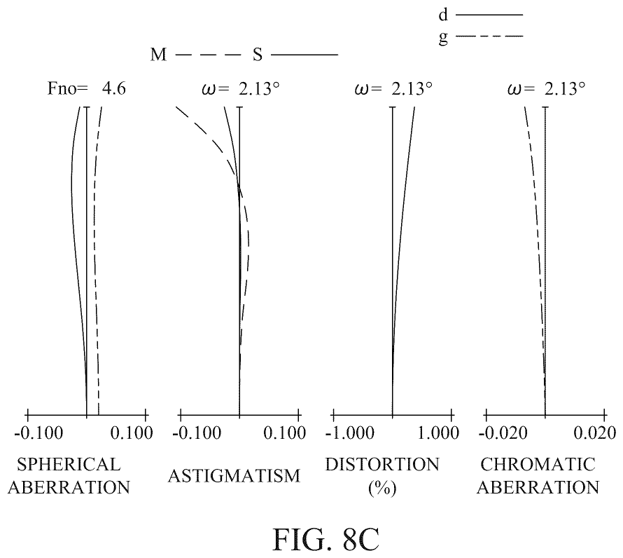

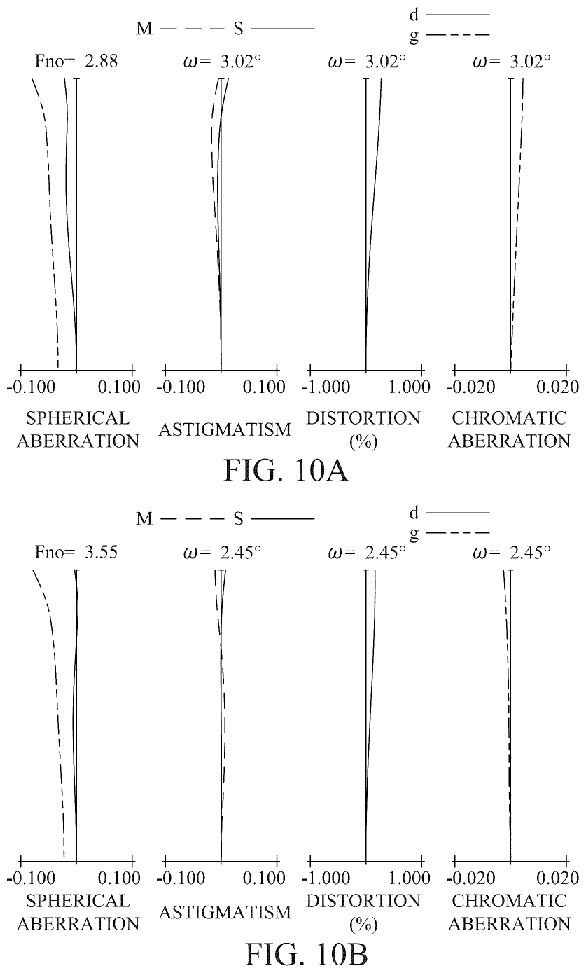

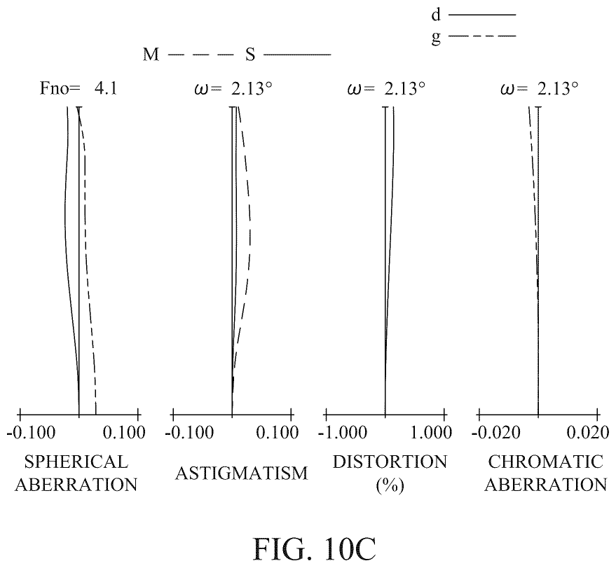

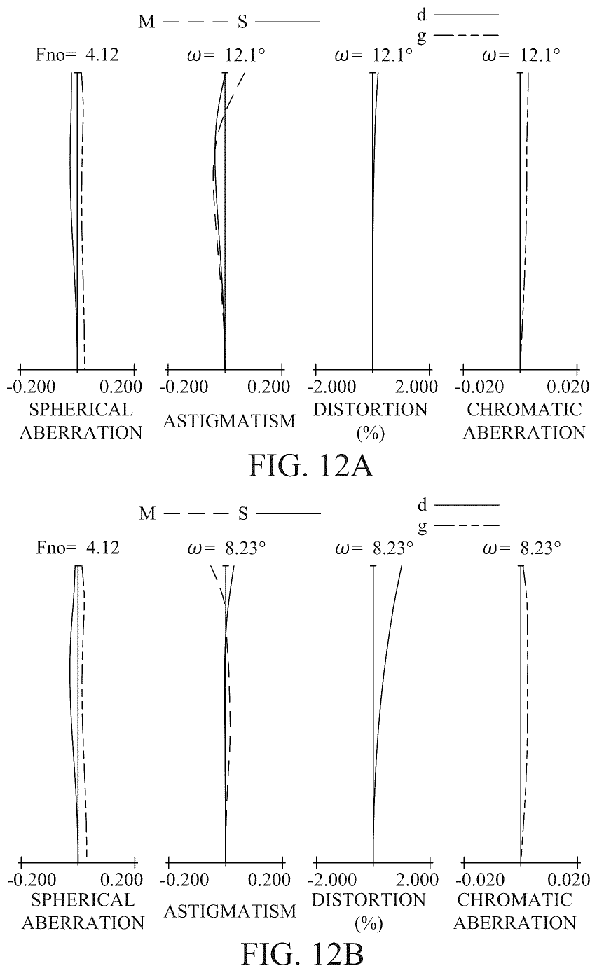

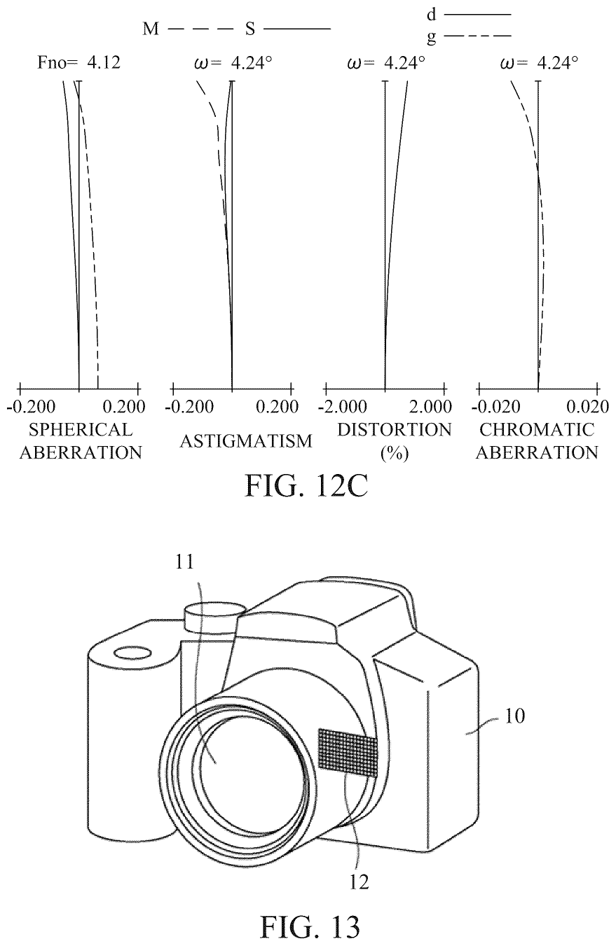

FIGS. 2A, 4A, 6A, 8A, 10A, and 12A are aberration diagrams of the zoom lenses according to Examples 1 to 6 at the wide-angle end, respectively. FIGS. 2B, 4B, 6B, 8B, 10B, and 12B are aberration diagrams of the zoom lenses according to Examples 1 to 6 at the intermediate zoom position, respectively. FIGS. 2C, 4C, 6C, 8C, 10C, and 12C are aberration diagrams of the zoom lenses according to Examples 1 to 6 at the telephoto end, respectively.

In each spherical aberration diagram, Fno denotes an F number and spherical aberration amounts for a d-line (wavelength 587.6 nm) and a g-line (wavelength 435.8 nm) are indicated. In each astigmatism diagram, ΔS indicates an astigmatism amount on a sagittal image plane, and ΔM indicates an astigmatism amount on a meridional image plane. In each distortion diagram, a distortion amount for the d-line is indicated. In each chromatic aberration diagram, a chromatic aberration amount for the g-line is indicated. ω is an image pickup half angle of view (°), which is an angle of view based on paraxial calculation.

Next, characteristic configurations of the zoom lens according to each example will be described.

The zoom lens according to each example comprises a first lens unit L1 having a positive refractive power (optical power=reciprocal of focal length), a front group U which includes one or two lens units and has a negative refractive power as a whole, and a rear group which includes an aperture stop SP and one or more lens units, which are arranged in order from the object side to the image side. In a region on a telephoto side, variations in a spherical aberration and a comatic aberration due to manufacturing errors become large, so the zoom lens according to each example is a so-called positive lead type zoom lens in which the first lens unit L1 has the positive refractive power. This makes it possible to suppress a height of incidence of axial light rays to a lens element placed on the image side of the front group U, so that while reducing a size of the zoom lens, various aberrations such as a chromatic aberration and a spherical aberration can be favorably corrected over an entire zoom range.

In the zoom lens according to each example, the first lens unit L1 is fixed relative to the image plane during focusing. In addition, in the zoom lens according to each of Examples 1, 2, 4, and 5, the first lens unit L1 is fixed relative to the image plane during zooming. By fixing the first lens unit L1 relative to the image plane during zooming, it is possible to suppress changes in an overall lens length during zooming. Furthermore, the number of movable units can be reduced, leading to the simplification of mechanical components. The simplification of mechanical components can reduce generation of dust and the like. Furthermore, it can ensure strength when attaching accessories such as a front filter and a converter lens.

In the zoom lens according to each example, the first lens unit L1 includes a positive lens L disposed closest to the object. The first lens unit L1 converges axial light rays, and prevents the zoom lens from becoming large due to making the zoom lens telephoto or have a large aperture. By disposing the positive lens L closest to the object in the first lens unit L1, the zoom lens can be made smaller and a spherical aberration can be easily corrected. In addition, by converging the axial light rays using the positive lens L and arranging other lenses at appropriate air intervals, a diameter of each lens can be reduced, making it easy to reduce the weight of the zoom lens.

In the zoom lens according to each example, at the telephoto end, a combined refractive power from the positive lens to a lens disposed closest to the image in the front group U is negative. The front group U is a lens unit (main variable magnification unit) that mainly performs a variable magnification function. In order to obtain a predetermined zoom ratio, it is necessary to strengthen the refractive power of the front group U or to increase a movement amount during zooming. In the zoom lens according to each example, the weight of the zoom lens can be easily reduced by simplifying the configuration of the front group U and suppressing fluctuations in the image plane during zooming. By simplifying the configuration of the front group U, it is possible to correct a curvature of field in a wide-angle range and a spherical aberration in a telephoto range while suppressing variations in a spherical aberration and a coma aberration in the telephoto range due to manufacturing errors caused by variations in a lateral chromatic aberration and an eccentricity during zooming.

The zoom lens according to each example satisfies the following inequalities (1) to (3).

$$0.10 < dsw / Ldw < 0 \text{.50} \qquad ( 1 )$$

$$1.45 < nd 1 max \leq 1.8 \qquad ( 2 )$$

$$3 < d 1 a / dUa < 300 \qquad ( 3 )$$

Here, dsw is a distance on an optical axis from the aperture stop SP to the image plane IP at the wide-angle end. Ldw is a total length of the zoom lens according to each example at the wide-angle end (overall lens length; a distance on the optical axis from a lens surface closest to the object to the image plane IP). nd1max is a maximum refractive index of lenses included in the first lens unit L1. d1a is a maximum value of air intervals (lens intervals) in the first lens unit L1 in the entire zoom range. dUa is a maximum value of air intervals in the front group U in the entire zoom range.

The inequality (1) defines the distance on the optical axis from the aperture stop SP to the image plane IP at the wide-angle end and the total length of the zoom lens at the wide-angle end. By satisfying the inequality (1), it is possible to shorten the total length of the zoom lens and suppress the occurrence of various aberrations, particularly a distortion and a chromatic aberration such as a lateral chromatic aberration. In a case where the value is lower than the lower limit of the inequality (1), the total length of the zoom lens increases, which is not preferable. In a case where the value is larger than the upper limit of the inequality (1), an increase in the aperture diameter and an increase in the diameter of the rear group are caused, making it difficult to reduce the weight, especially of a focus lens unit.

The inequality (2) defines the maximum value of the refractive indices in the d-line (maximum refractive index) of the lenses included in the first lens unit L1. Satisfying the inequality (2) allows for both a weight reduction and a chromatic aberration correction. In the lenses included in the first lens unit L1, a composite optical element such as a replica resin layer (referred to as a hybrid aspherical surface or a replica aspherical surface) is a single lens element including the resin layer. Specifically, for example, an element including the resin layer with a thickness of 0.3 mm or less on the optical axis is defined as a single lens element. Furthermore, when specifying materials, calculations are made without considering the resin layer. In general, an Abbe number tends to decrease as a refractive index of a lens material increases. Furthermore, as the refractive index increases, a partial dispersion ratio θgF tends to increase, and a specific gravity tends to increase. In a case where a material below the lower limit of the inequality (2) is used, the refractive index becomes low, making it difficult to arrange a lens with a small Abbe number, and achromatization in the first lens unit L1 is likely to be insufficient. Furthermore, if an attempt is made to ensure the achromatic effect, it results in insufficient correction of a spherical aberration, especially on the telephoto side, which is not preferable. In a case where a material exceeding the upper limit of the inequality (2) is used, a lens with a high refractive index, a small Abbe number, and a large partial dispersion ratio θgF is disposed. This is not preferable because it causes insufficient correction of an axial chromatic aberration over the entire zoom range and a lateral chromatic aberration on the telephoto side in the first lens unit L1. Furthermore, even if a lens with a high refractive index is used to reduce the number of lens components, this is not preferable because the mass of the lens tends to increase.

The inequality (3) defines the maximum value of the air intervals in the first lens unit L1 and the front group U. By satisfying the inequality (3), it is possible to both suppress various aberrations and reduce the weight of the zoom lens. In a case where the value is lower than the lower limit of the inequality (3), it becomes difficult to arrange a principal point of the front group U on the image side at the telephoto end. In order to achieve miniaturization while ensuring a desired variable magnification ratio, it is necessary to increase the refractive power of the first lens unit L1 and the front group U, which tends to lead to an increase in the number of lenses. In a case where the value is larger than the upper limit of the inequality (3), the thickness of the first lens unit L1 on the optical axis becomes large, leading to an increase in a radial direction of the positive lens L, making it difficult to reduce the weight. Furthermore, it becomes difficult to suppress a coma aberration on the telephoto side.

The configuration described above enables the realization of the zoom lens that is compact and has a large aperture, yet provides high optical performance.

The numerical ranges of the inequalities (1) to (3) are more preferably the numerical ranges of the inequalities (1a) to (3a) below.

$$0.2 < dsw / Ldw < 0 \text{.49} \qquad ( 1 a )$$

$$1.55 < nd 1 max \leq 1.8 \qquad ( 2 a )$$

$$3.5 < d 1 a / dUa < 50.0 \qquad ( 3 a )$$

Further, the numerical ranges of the inequalities (1) to (3) are more preferably the numerical ranges of the inequalities (1b) to (3b) below.

$$0.30 < dsw / Ldw < 0 \text{.49} \qquad ( 1 b )$$

$$1.6 < nd 1 max \leq 1.8 \qquad ( 2 b )$$

$$3.8 < d 1 a / dUa < 10.0 \qquad ( 3 b )$$

Next, configurations that are preferably satisfied in the zoom lens according to each example will be described.

It is preferable that the first lens unit L1 is composed of four or less lenses. By reducing the number of lenses in the first lens unit L1, which has a large lens diameter, it is possible to reduce the size and weight. Furthermore, a height of a light ray exiting from the first lens unit L1 can be lowered, and various off-axis aberrations such as a coma aberration and a curvature of field can be favorably corrected.

The first lens unit L1 is preferably composed of one negative lens and two or three positive lenses. With such a configuration, it becomes easy to satisfactorily correct an axial chromatic aberration and a lateral chromatic aberration over the entire zoom range, and to satisfactorily correct a spherical aberration and an axial chromatic aberration on the telephoto side associated with an increase in the aperture.

The front group U is preferably composed of three or four spherical lenses, including at least one positive lens. Thereby, it is possible to suppress surface shape errors (errors in the so-called astigmatism or irregularity component) that tend to occur with aspherical lenses. Further, while increasing the refractive power of the second lens unit L2, it is possible to simultaneously correct a lateral chromatic aberration and a curvature of field in the wide-angle range and correct a spherical aberration in the telephoto range.

It is preferable that the rear group includes a lens unit LA having a positive refractive power, disposed closest to the object, and the lens unit LA is fixed relative to the image plane IP during zooming. This makes it easy to ensure an eccentric position accuracy as the aperture increases and the total length of the zoom lens is shortened, and it is possible to reduce an eccentric comatic aberration and an eccentric astigmatism during zooming caused by manufacturing errors. Furthermore, the number of movable units during zooming can be reduced, the zoom lens can be made smaller and the configuration can be simplified, and the imaging performance of the zoom lens can be easily ensured.

It is preferable that the lens unit LA has at least three positive lenses. This makes it possible to satisfactorily correct variations in an axial chromatic aberration and a spherical aberration for each wavelength that occur due to an increase in the aperture.

A lens unit disposed closest to the image is preferably fixed relative to the image plane IP during zooming. This makes it possible to reduce the generation of dust and the like when the zoom lens is removed, making it easier to ensure durability.

A lens disposed closest to the image in the zoom lens is preferably a lens having a convex shape on the image side. This makes it relatively easy to ensure a back focus, and also suppresses the collection of unnecessary light (ghost) caused by the image sensor.

The aperture stop SP is preferably arranged closer to the image than the lens unit LA. This makes it easy to suppress an enlargement of a diaphragm member that occur due to an increase in the aperture.

A lens arranged adjacent to the image side of the aperture stop SP is preferably composed of an element (single lens or cemented lens) having a convex shape on the object side. This makes it easier to suppress a spherical aberration and to correct various off-axis aberrations in the wide-angle range, associated with a larger aperture. Further, in a case where the convex element is a cemented lens, it is easy to correct a spherical aberration and a coma aberration, and correct a curvature of field.

Preferably, the zoom lens according to each example does not include a diffractive optical element. Providing the diffractive optical element is not preferable because diffraction flare occurs.

It is preferable to perform zooming so that a distance between the first lens unit L1 and the front group U is wider at the telephoto end than at the wide-angle end, and a distance between the front group U and the rear group is narrower at the telephoto end than at the wide-angle end. Thereby, it is possible to reduce the weight while increasing the aperture.

In a case where the front group U consists of two lens units, it is preferable to change an interval in the front group U during zooming. This makes it possible to satisfactorily correct variations in a spherical aberration and a curvature of field due to zooming.

Next, conditions that are preferably satisfied by the zoom lens according to each example will be described. It is preferable that the zoom lens according to each example satisfies one or more of the following inequalities (4) to (12).

$$1.75 < ndUv < 2.4 \qquad ( 4 )$$

$$0.56 < θ gFUv < 0.68 \qquad ( 5 )$$

$$56 < ν d 1 a < 100 \qquad ( 6 )$$

$$- 35. < β Ut < - 0.45 \qquad ( 7 )$$

$$1.7 < β Ut / β Uw < 20. \qquad ( 8 )$$

$$2.4 < f 1 / fLA < 10. \qquad ( 9 )$$

$$- 0.3 \; 5 < fU / f t < - 0.05 \qquad ( 10 )$$

$$0.01 < skt / f t < 0. 35 \qquad ( 11 )$$

$$- 9. < f 1 / fU < - 1.6 \qquad ( 12 )$$

Here, ndUV is a refractive index of a lens made of a material having a maximum refractive index among lenses included in the front group U. θgFUv is a partial dispersion ratio of the lens made of the material having the maximum refractive index among the lenses included in the front group U. νd1a is an average value of Abbe numbers in the d-line of lenses included in the first lens unit L1. βUt is a lateral magnification of the front group U at the telephoto end (in a case where the front group U is composed of a plurality of lens units, βUt is a combined lateral magnification). βUw is a lateral magnification of the front group U at the wide-angle end (imaging magnification; in a case where the front group U is composed of a plurality of lens units, βUw is a combined lateral magnification). f1 is a focal length of the first lens unit L1. fLA is a focal length of the lens unit LA disposed closest to the object in the rear group. fU is a focal length of the front group U at the telephoto end (in a case where the front group U is composed of a plurality of lens units, fU is a combined focal length). ft is a focal length of the zoom lens at the telephoto end. skt is a back focus (a distance on the optical axis from a lens surface closest to the image to the image plane IP) at the telephoto end.

The inequality (4) defines the refractive index of the lens made of the material having the maximum refractive index among the lenses included in the front group U. Due to the characteristics of glass, as the refractive index increases, the Abbe number tends to decrease while the partial dispersion ratio tends to increase. In a case where a material with a high refractive index is used for a positive lens of the front group U, which has a negative refractive index as a whole, it is easier to perform achromatization in the front group U and correction to a secondary spectrum of axial and lateral chromatic aberrations in the zoom lens. Furthermore, by forming the lens using the material with the high refractive index, a curvature becomes small (a radius of curvature becomes large), and a spherical aberration can be easily corrected. Furthermore, it becomes easier to reduce the number of lenses in the front group U, which has a relatively large diameter, while properly correcting a curvature of field and an astigmatism. In a case where the value is lower than the lower limit of the inequality (4), it is necessary to weaken the refractive power of the front group U in order to correct a curvature of field, which results in an increase in the total length of the zoom lens and an increase in the movement amount of the front group U, which is not preferable. In a case where the value is larger than the upper limit of the inequality (4), variations (curvature) of a lateral chromatic aberration for each image height becomes large.

The inequality (5) defines the partial dispersion ratio of the lens made of the material having the maximum refractive index among the lenses included in the front group U. By satisfying the inequality (5), it is possible to achieve a good balance between suppressing fluctuations in a chromatic aberration including a lateral chromatic aberration and am axial chromatic aberration during zooming, and suppressing a lateral chromatic aberration in the telephoto range. In a case where the value is lower than the lower limit of the inequality (5), the axial chromatic aberration correcting effect of the positive lens included in the front group U becomes weaker, and it becomes necessary to strengthen the convergence effect of the first lens unit L1 and to suppress a height of a light ray incident on the second lens unit L2 arranged on the image side of the first lens unit L1. This is not preferable because the refractive power of the first lens unit L1 becomes stronger, the number of lenses increases, and the mass increases. In a case where the value is larger than the upper limit of the inequality (5), this is not preferable because it increases fluctuations in an axial chromatic aberration during zooming and increases variations in spherical and coma aberrations for each wavelength.

The inequality (6) defines the average value of the Abbe numbers in the d-line of the lenses included in the first lens unit L1. By satisfying the inequality (6), it becomes possible to reduce the weight of the zoom lens and to satisfactorily correct various aberrations including a chromatic aberration. In a case where the value is lower than the lower limit of the inequality (6), a generation amount of the chromatic aberration in the first lens unit L1 becomes too large, making it difficult to correct various aberrations including the chromatic aberration in a well-balanced manner across the entire zoom lens. In a case where the value is larger than the upper limit of the inequality (6), it becomes difficult to ensure transmittance of glass materials forming lenses.

The inequality (7) defines the lateral magnification of the front group U at the telephoto end. In a case where the value is lower than the lower limit of the inequality (7), it is difficult to obtain the desired variable magnification ratio, and the rear group shares the variable magnification, resulting in an increase in the size of the zoom lens. In a case where the value is larger than the upper limit of the inequality (7), it is advantageous for ensuring a high variable magnification ratio. On the other hand, the magnification of the front group U at the telephoto end becomes too large, making it difficult to suppress a curvature of field and a distortion in the wide-angle range.

The inequality (8) defines the relationship between the lateral magnifications of the front group U at the telephoto end and the wide-angle end. By satisfying the inequality (8), a high variable magnification ratio can be ensured. In a case where the value is lower than the lower limit of the inequality (8), the variable magnification function of the front group U is small, and it is necessary to ensure the variable magnification function of the rear group, so that it becomes difficult to suppress a lateral chromatic aberration and a distortion in the telephoto range, making it difficult to achieve miniaturization. In a case where the value is larger than the upper limit of the inequality (8), fluctuations in the image plane during zooming increase, making it difficult to maintain high optical performance.

The inequality (9) defines the relationship between the focal length of the first lens unit L1 and the focal length of the lens unit LA disposed closest to the object in the rear group. By satisfying the inequality (9), it is possible to increase the aperture while satisfactorily suppressing a spherical aberration and a coma aberration. In a case where the value is lower than the lower limit of the inequality (9), it is difficult to correct a spherical aberration and a comatic aberration, which is not preferable. In a case where the value is larger than the upper limit of the inequality (9), the refractive power of the first lens unit L1 is small, making it difficult to shorten the total length of the zoom lens, which is not preferable. Furthermore, it becomes difficult to achieve a high zoom ratio.

The inequality (10) defines the relationship between the focal length of the front group U at the telephoto end and the focal length of the zoom lens at the telephoto end. By satisfying the inequality (10), it is possible to achieve both a high variable magnification and miniaturization. In a case where the value is lower than the lower limit of the inequality (10), a Petzval sum becomes negatively large, which is not preferable as it increases the curvature of field. In a case where the value is larger than the upper limit of the inequality (10), in order to increase the high variable magnification, it is necessary to increase the movement amount of the second lens unit L2, or to increase the variable magnification function of a lens unit disposed on the image side of the second lens unit L2. When the movement amount of the second lens unit L2 is increased, the total length of the zoom lens becomes long, which is not preferable. Furthermore, increasing the variable magnification function of the lens unit disposed on the image side of the second lens unit L2 is not preferable because the total length of the zoom lens becomes long and the number of lenses increases.

The inequality (11) defines the relationship between the back focus at the telephoto end and the focal length of the zoom lens at the telephoto end, the so-called retro ratio. In a case where the value is lower than the lower limit of the inequality (11), it becomes difficult to arrange a shutter member and the like. In a case where the value is larger than the upper limit of the inequality (11), it becomes difficult to correct a distortion and a curvature of field, leading to an increase in the number of lenses, which is not preferable.

The inequality (12) defines the relationship between the focal length of the first lens unit L1 and the focal length of the front group U at the telephoto end. In a zoom lens that is relatively bright on the telephoto side, if the refractive power of the first lens unit L1 is not appropriately secured within the range where aberration correction is possible, the total length of the zoom lens in the telephoto side increases and the diameter of a front lens becomes large in order to ensure an amount of peripheral light. By satisfying the inequality (12), it is possible to maintain an appropriate variable magnification ratio and downsize the zoom lens. In a case where the value is lower than the lower limit of the inequality (12), it becomes difficult to correct a spherical aberration on the telephoto side. In a case where the value is larger than the upper limit of the inequality (12), aberration fluctuations of the first lens unit L1 and the front group U during zooming become large, and it becomes particularly difficult to suppress a curvature of field.

The numerical ranges of the inequalities (4) to (12) are more preferably the numerical ranges of the inequalities (4a) to (12a) below.

$$1.78 < ndUv < 2.1 \qquad ( 4 a )$$

$$0.57 < θ gFUv < 0.675 \qquad ( 5 a )$$

$$60 < vd 1 a < 100 \qquad ( 6 a )$$

$$- 31. < β Ut < - 0.5 \qquad ( 7 a )$$

$$1.8 < β Ut / β Uw < 14. \qquad ( 8 a )$$

$$2.5 < f 1 / fLA < 8. \qquad ( 9 a )$$

$$- 0.3 < fU / ft < - 0.1 \qquad ( 10 a )$$

$$0.03 < skt / ft < 0.3 \qquad ( 11 a )$$

$$- 7.5 < f 1 / fU < - 2.2 \qquad ( 12 a )$$

Further, the numerical ranges of the inequalities (4) to (12) are more preferably the numerical ranges of the inequalities (4b) to (12b) below.

$$1.8 < ndUv < 2. \qquad ( 4 b )$$

$$0.575 < θ gFUv < 0.67 \qquad ( 5 b )$$

$$62 < vd 1 a < 100 \qquad ( 6 b )$$

$$- 30.5 < β Ut < - 0.52 \qquad ( 7 b )$$

$$1.9 < β Ut / β Uw < 12. \qquad ( 8 b )$$

$$2.6 < f 1 / fLA < 6.8 \qquad ( 9 b )$$

$$- 0.25 < fU / ft < - 0.15 \qquad ( 10 b )$$

$$0.05 < skt / ft < 0.25 \qquad ( 11 b )$$

$$- 6. < f 1 / fU < - 2.8 \qquad ( 12 b )$$

Next, the zoom lens according to each example will be described in detail.

The zoom lens according to each of Examples 1 to 3 is composed of the first lens unit L1 having a positive refractive power, the second lens unit L2 having a negative refractive power, and the rear group, which are arranged in order from the object side to the image side. In the zoom lens according to each of Examples 1 to 3, the second lens unit L2 corresponds to the front group U. The zoom lens according to each of Examples 4 to 6 is composed of the first lens unit L1 having a positive refractive power, the second lens unit L2 having a negative refractive power, the third lens unit L3, and the rear group, which are arranged in order from the object side to the image side. In the zoom lens according to each of Examples 4 to 6, the second lens unit L2 and the third lens unit L3 correspond to the front group U.

The zoom lens according to Example 1 has a zoom ratio of 1.4 and an aperture ratio of about 2.9 to 4.1. In Example 1, the rear group is composed of the third lens unit L3 to the eighth lens unit L8 having positive, positive, negative, positive, negative, and positive refractive powers, which are arranged in order from the object side to the image side. In a reference state where an object distance is infinite, during zooming from the wide-angle end to the telephoto end, the first lens unit L1, the third lens unit L3, the sixth lens unit L6, and the eighth lens unit L8 are fixed relative to the image plane IP. During zooming from the wide-angle end to the telephoto end, the second lens unit L2 moves toward the image side, the fourth lens unit L4 moves in a convex trajectory toward the object side, and the fifth lens unit L5 and the seventh lens unit L7 move toward the object side. During focusing on a close object, the fifth lens unit L5 and the seventh lens unit L7 move toward the image side.

The zoom lens according to Example 2 has a zoom ratio of 1.9 and an aperture ratio of about 2.9 to 4.6. In Example 2, the rear group is composed of the third lens unit L3 to the eighth lens unit L8 having positive, positive, negative, negative, positive, and negative refractive powers, which are arranged in order from the object side to the image side. In a reference state where an object distance is infinite, during zooming from the wide-angle end to the telephoto end, the first lens unit L1, the third lens unit L3, the sixth lens unit L6, and the eighth lens unit L8 are fixed relative to the image plane IP. During zooming from the wide-angle end to the telephoto end, the second lens unit L2 moves toward the image side, the fourth lens unit L4 moves in a convex trajectory toward the object side, and the fifth lens unit L5 moves toward the object side, and the seventh lens unit L7 move toward the image side. During focusing on a close object, the fifth lens unit L5 moves toward the image side, and the seventh lens unit L7 move toward the object side.

The zoom lens according to Example 3 has a zoom ratio of 4.0 and an aperture ratio of about 4.1 to 4.1. In Example 3, the rear group is composed of the third lens unit L3 to the fifth lens unit L5 having positive, negative, and positive refractive powers, which are arranged in order from the object side to the image side. In a reference state where an object distance is infinite, during zooming from the wide-angle end to the telephoto end, each lens unit moves. During focusing on a close object, the fourth lens unit L4 moves toward the image side.

The zoom lens according to Example 4 has a zoom ratio of 1.9 and an aperture ratio of about 2.9 to 4.6. In Example 4, the rear group is composed of the fourth lens unit L4 to the ninth lens unit L9 having positive, positive, negative, negative, positive, and negative refractive powers, which are arranged in order from the object side to the image side. In a reference state where an object distance is infinite, during zooming from the wide-angle end to the telephoto end, the first lens unit L1, the fourth lens unit L4, the seventh lens unit L7, and the ninth lens unit L9 are fixed relative to the image plane IP. During zooming from the wide-angle end to the telephoto end, the second lens unit L2 and the third lens unit L3 move toward the image side, the fifth lens unit L5 moves in a convex trajectory toward the object side, and the sixth lens unit L6 moves toward the object side, and the eighth lens unit L8 move toward the image side. During focusing on a close object, the sixth lens unit L6 moves toward the image side, and the eighth lens unit L8 moves toward the object side.

The zoom lens according to Example 5 has a zoom ratio of 1.4 and an aperture ratio of about 2.9 to 4.1. In Example 5, the rear group is composed of the fourth lens unit L4 to the ninth lens unit L9 having positive, positive, negative, positive, negative, and positive refractive powers, which are arranged in order from the object side to the image side. In a reference state where an object distance is infinite, during zooming from the wide-angle end to the telephoto end, the first lens unit L1, the fourth lens unit L4, the seventh lens unit L7, and the ninth lens unit L9 are fixed relative to the image plane IP. During zooming from the wide-angle end to the telephoto end, the second lens unit L2 and the third lens unit L3 move toward the image side, the fifth lens unit L5 moves in a convex trajectory toward the object side, and the sixth lens unit L6 moves toward the object side, and the eighth lens unit L8 move toward the object side. During focusing on a close object, the sixth lens unit L6 and the eighth lens unit L8 move toward the image side.

The zoom lens according to Example 6 has a zoom ratio of 2.9 and an aperture ratio of about 4.1. In Example 6, the rear group is composed of the fourth lens unit L4 to the sixth lens unit L6 having positive, negative, and positive refractive powers, which are arranged in order from the object side to the image side. In a reference state where an object distance is infinite, during zooming from the wide-angle end to the telephoto end, each lens unit moves. During focusing on a close object, the fifth lens unit L5 moves toward the image side.

In the zoom lens according to each example, an image stabilization can be performed by moving the whole or a part of one of the lens units as an image stabilization unit so as to include a component in a direction perpendicular to the optical axis, or rotationally moving (swinging) the whole or the part in a plane including the optical axis. For example, in the zoom lens according to Example 1, the image stabilization can be performed by moving the 16th to 18th lenses so as to include a component in a direction perpendicular to the optical axis. There are no particular restrictions on the number or shape of lenses in the image stabilization unit. Further, it is preferable that the image stabilization unit has a negative refractive power as a whole.

Numerical Examples 1 to 6 corresponding to Examples 1 to 6 will be illustrated below.

In each numerical example, m represents the number of surfaces counted from a light incident side, r represents a radius of curvature of each optical surface, and d (mm) represents an interval (distance) between the m-th surface and the (m+1)-th surface on the optical axis. nd represents a refractive index of each optical member for the d-line, and νd represents an Abbe number of each optical member. The Abbe number νd and the partial dispersion ratio θgF of a certain material are expressed as follows:

$$vd = ( Nd - 1 ) / ( NF - NC )$$

$$θ = ( Ng - NF ) / ( NF - NC )$$

where Nd, NF, NC, and Ng are refractive indices for the d-line (587.6 nm), F-line (486.1 nm), C-line (656.3 nm), and g-line (435.8 nm) in the Fraunhofer line, respectively.

In each numerical example, d, focal length (mm), F number, and half angle of view (°) are all values when the zoom lens according to each example focuses on an object at infinity. “Back focus” is a distance on the optical axis from the final lens surface (the lens surface closest to the image) to the paraxial image plane in terms of air conversion length. In a case where an optical member with an extremely weak refractive power is disposed between the zoom lens and the image sensor, the back focus is used as an air equivalent of the optical member with the extremely weak refractive power disposed between the zoom lens and the image sensor. “Overall lens length” is a value obtained by adding the back focus to a distance on the optical axis from the frontmost surface (lens surface closest to the object) of the zoom lens to the final surface of the zoom lens. “Lens unit” is not limited to a case where it is composed of a plurality of lenses, but also includes a case where it is composed of a single lens.

An asterisk * is attached to the right side of the surface number in a case where an optical surface is an aspherical surface. The aspherical shape is expressed as follows:

$$X = \frac{\frac{{H}^{2}}{R}}{1 + \sqrt{1 - ( 1 + k ) {( \frac{H}{R} )}^{2}}} + A 4 {H}^{4} + A 6 {H}^{6} + A 8 {H}^{8} + A {10}^{10} + A 12 {H}^{12}$$

where X is a displace amount from a surface vertex in the optical axis direction, H is a height from the optical axis in a direction perpendicular to the optical axis, R is a paraxial radius of curvature, K is a conic constant, and A4, A6, A8, A10, and A12 are aspheric coefficients. In each aspheric shape, “e±XX” means “×10±XX”.

### Numerical Example 1

UNIT: mm
Surface Data

| Surface No. | r | d | nd | νd | θgF |
|---|---|---|---|---|---|
| 1 | 730.9556 | 5.892 | 1.51860 | 69.89 | 0.5318 |
| 2 | −6243.5126 | 0.500 | | | |
| 3 | 198.7095 | 16.104 | 1.43387 | 95.10 | 0.5373 |
| 4 | −3325.1197 | 79.136 | | | |
| 5 | 155.0904 | 9.320 | 1.43387 | 95.10 | 0.5373 |
| 6 | 1493.6041 | 1.635 | | | |
| 7 | −1752.4247 | 2.500 | 1.65412 | 39.68 | 0.5737 |
| 8 | 198.0530 | (Variable) | | | |
| 9 | 411.1739 | 4.561 | 1.89286 | 20.36 | 0.6393 |
| 10 | −443.2523 | 1.800 | 1.75700 | 47.82 | 0.5565 |
| 11 | 111.4148 | 10.005 | | | |
| 12 | −125.4127 | 1.800 | 1.61772 | 49.81 | 0.5603 |
| 13 | −376.7073 | (Variable) | | | |
| 14 | 323.1596 | 9.629 | 1.43387 | 95.10 | 0.5373 |
| 15 | −143.7175 | 0.300 | | | |
| 16 | 174.5820 | 7.144 | 1.49700 | 81.54 | 0.5375 |
| 17 | −610.1252 | 0.300 | | | |
| 18 | 102.2907 | 12.593 | 1.43875 | 94.66 | 0.5340 |
| 19 | −170.4620 | 1.500 | 1.85150 | 40.78 | 0.5695 |
| 20 | 288.0578 | (Variable) | | | |
| 21 | 122.2879 | 6.365 | 1.49700 | 81.54 | 0.5375 |
| 22 | −891.3501 | (Variable) | | | |
| 23 (Aperture Stop) | ∞ | (Variable) | | | |
| 24 | −1838.6951 | 1.000 | 1.77250 | 49.60 | 0.5520 |
| 25 | 63.1863 | (Variable) | | | |
| 26 | 67.3791 | 1.000 | 1.89286 | 20.36 | 0.6393 |
| 27 | 45.1355 | 7.018 | 1.61772 | 49.81 | 0.5603 |
| 28 | −148.0674 | 1.000 | | | |
| 29 | 617.5001 | 4.586 | 1.66565 | 35.64 | 0.5824 |
| 30 | −59.6998 | 1.200 | 1.55200 | 70.70 | 0.5421 |
| 31 | 45.6096 | 4.496 | | | |
| 32 | −116.6098 | 1.200 | 1.49700 | 81.54 | 0.5375 |
| 33 | 68.7125 | 2.622 | | | |
| 34 | 53.7871 | 6.809 | 1.58144 | 40.75 | 0.5774 |
| 35 | −91.7944 | (Variable) | | | |
| 36 | 290.3730 | 1.300 | 1.49700 | 81.54 | 0.5375 |
| 37 | 81.1764 | 7.199 | | | |
| 38 | −38.3664 | 1.350 | 1.85896 | 22.73 | 0.6284 |
| 39 | −44.9029 | (Variable) | | | |
| 40 | 54.6122 | 4.669 | 1.54814 | 45.79 | 0.5686 |
| 41 | 225.7345 | 5.070 | | | |
| 42 | −77.3223 | 1.500 | 1.49700 | 81.54 | 0.5375 |
| 43 | −337.7382 | 39.500 | | | |
| Image Plane | ∞ | | | | |

Various Data
Zoom Ratio 1.424

| | Wide | Middle | Tele |
|---|---|---|---|
| Focal Length: | 409.335 | 505.051 | 582.738 |
| Fno | 2.880 | 3.553 | 4.100 |
| Half Angle of View (°) | 3.025 | 2.453 | 2.126 |
| Image Height | 21.635 | 21.635 | 21.635 |
| Overall lens length | 475.002 | 475.002 | 475.002 |
| BF | 39.500 | 39.500 | 39.500 |
| d 8 | 75.292 | 102.470 | 123.027 |
| d13 | 51.451 | 24.274 | 3.716 |
| d20 | 16.196 | 12.309 | 16.151 |
| d22 | 4.395 | 8.282 | 4.440 |
| d23 | 21.740 | 11.632 | 5.653 |
| d25 | 20.779 | 30.887 | 36.866 |
| d35 | 5.522 | 3.808 | 2.263 |
| d39 | 17.024 | 18.738 | 20.283 |

Zoom Lens Unit Data

| Unit | Starting Surface | Focal Length |
|---|---|---|
| 1 | 1 | 410.021 |
| 2 | 9 | −130.744 |
| 3 | 14 | 133.646 |
| 4 | 21 | 216.820 |
| 5 | 23 | ∞ |
| 6 | 24 | −79.059 |
| 7 | 26 | 120.226 |
| 8 | 36 | −135.543 |
| 9 | 40 | 326.087 |

Focus 24-25 Surfaces/36-39 Surfaces

| | Wide | Middle | Tele |
|---|---|---|---|
| INF | 0/0 | 0/0 | 0/0 |
| 10 m | 4.425/1.194 | 6.260/1.702 | 7.991/2.188 |
| 5 m | 8.968/2.466 | 12.783/3.570 | 16.500/4.678 |

### Numerical Example 2

UNIT: mm
Surface Data

| Surface No. | r | d | nd | νd | θgF |
|---|---|---|---|---|---|
| 1 | 570.3427 | 5.308 | 1.55397 | 71.76 | 0.5389 |
| 2 | 4110.5896 | 0.500 | | | |
| 3 | 180.9086 | 14.162 | 1.43387 | 95.10 | 0.5373 |
| 4 | −16508.0671 | 79.751 | | | |
| 5 | 139.9369 | 7.584 | 1.43387 | 95.10 | 0.5373 |
| 6 | 653.8269 | 1.766 | | | |
| 7 | −4831.6176 | 2.500 | 1.65412 | 39.68 | 0.5737 |
| 8 | 174.5670 | (Variable) | | | |
| 9 | 518.2941 | 2.000 | 1.75500 | 52.32 | 0.5475 |
| 10 | 122.9643 | 8.588 | | | |
| 11 | −110.2774 | 2.000 | 1.43875 | 94.66 | 0.5340 |
| 12 | 580.4461 | 2.754 | 1.94594 | 17.98 | 0.6546 |
| 13 | −1719.8627 | (Variable) | | | |
| 14 | 542.7184 | 9.491 | 1.43875 | 94.66 | 0.5340 |
| 15 | −140.9845 | 0.300 | | | |
| 16 | 214.1095 | 8.022 | 1.43875 | 94.66 | 0.5340 |
| 17 | −340.1080 | 0.300 | | | |
| 18 | 119.2253 | 13.087 | 1.43875 | 94.66 | 0.5340 |
| 19 | −160.9653 | 1.800 | 1.88300 | 40.76 | 0.5667 |
| 20 | 422.5642 | (Variable) | | | |
| 21 | 101.4565 | 8.513 | 1.43875 | 94.66 | 0.5340 |
| 22 | −706.5165 | (Variable) | | | |
| 23 (Aperture Stop) | ∞ | (Variable) | | | |
| 24 | 272.7897 | 2.275 | 1.86966 | 20.02 | 0.6434 |
| 25 | 1503.3424 | 1.200 | 1.85150 | 40.78 | 0.5695 |
| 26 | 63.1952 | (Variable) | | | |
| 27 | 56.6311 | 6.531 | 1.58313 | 59.38 | 0.5434 |
| 28 | −168.5178 | 1.400 | 1.98612 | 16.48 | 0.6657 |
| 29 | 416.0912 | 1.895 | | | |
| 30 | 12335.3111 | 4.342 | 1.72047 | 34.71 | 0.5834 |
| 31 | −66.3850 | 1.200 | 1.43875 | 94.66 | 0.5340 |
| 32 | 42.4384 | 5.451 | | | |
| 33 | −79.6923 | 1.200 | 1.61800 | 63.40 | 0.5395 |
| 34 | 164.6449 | 4.073 | | | |
| 35 | 158.9082 | 3.926 | 1.89286 | 20.36 | 0.6393 |
| 36 | −104.0776 | 1.882 | | | |
| 37 | 3107.5060 | 6.177 | 1.51680 | 64.20 | 0.5342 |
| 38 | −38.1010 | 1.500 | 1.69350 | 53.21 | 0.5473 |
| 39 | −76.7167 | 14.040 | | | |
| 40 | −2495.0850 | 1.802 | 1.98612 | 16.48 | 0.6657 |
| 41 | 289.7081 | 4.371 | | | |
| 42 | −55.9357 | 1.487 | 1.83400 | 37.34 | 0.5790 |
| 43 | −224.9602 | (Variable) | | | |
| 44 | 425.8906 | 5.874 | 1.65160 | 58.54 | 0.5390 |
| 45 | −57.2522 | (Variable) | | | |
| 46 | −72.2123 | 1.500 | 1.43875 | 94.66 | 0.5340 |
| 47 | −228.1975 | 41.785 | | | |
| Image Plane | ∞ | | | | |

Various Data
Zoom Ratio 1.902

| | Wide | Middle | Tele |
|---|---|---|---|
| Focal Length: | 306.239 | 400.502 | 582.535 |
| Fno | 2.900 | 3.284 | 4.600 |
| Half Angle of View (°) | 4.041 | 3.092 | 2.127 |
| Image Height | 21.635 | 21.635 | 21.635 |
| Overall lens length | 475.001 | 475.001 | 475.001 |
| BF | 41.785 | 41.785 | 41.785 |
| d 8 | 30.863 | 63.518 | 113.126 |
| d13 | 86.178 | 53.524 | 3.916 |
| d20 | 16.045 | 5.554 | 14.429 |
| d22 | 4.870 | 15.361 | 6.486 |
| d23 | 25.268 | 12.546 | 3.652 |
| d26 | 14.363 | 27.084 | 35.979 |
| d43 | 6.069 | 8.177 | 12.155 |
| d45 | 9.007 | 6.899 | 2.922 |

Zoom Lens Unit Data

| Unit | Starting Surface | Focal Length |
|---|---|---|
| 1 | 1 | 412.353 |
| 2 | 9 | −136.937 |
| 3 | 14 | 152.746 |
| 4 | 21 | 202.855 |
| 5 | 23 | ∞ |
| 6 | 24 | −97.865 |
| 7 | 27 | −222.023 |
| 8 | 44 | 77.826 |
| 9 | 46 | −241.489 |

Focus 24-25 Surfaces/44-45 Surfaces

| | Wide | Middle | Tele |
|---|---|---|---|
| INF | 0/0 | 0/0 | 0/0 |
| 10 m | 2.604/−1.258 | 4.033/−1.909 | 7.881/−3.525 |
| 5 m | 5.322/−2.473 | 8.265/−3.676 | 16.515/−6.419 |

### Numerical Example 3

UNIT: mm
Surface Data

| Surface No. | r | d | nd | νd | θgF |
|---|---|---|---|---|---|
| 1 | 117.8476 | 10.117 | 1.59410 | 60.47 | 0.5550 |
| 2 | −727.8101 | 18.200 | | | |
| 3 | 94.9790 | 8.242 | 1.49700 | 81.61 | 0.5386 |
| 4 | −252.5833 | 1.800 | 1.78800 | 47.37 | 0.5559 |
| 5 | 94.7236 | (Variable) | | | |
| 6 | 157.5616 | 1.500 | 1.79500 | 45.29 | 0.5600 |
| 7 | 39.1088 | 6.013 | | | |
| 8 | −383.4067 | 1.500 | 1.49700 | 81.61 | 0.5386 |
| 9 | 35.7445 | 7.507 | 1.83400 | 37.34 | 0.5790 |
| 10 | −23201.6288 | 3.000 | | | |
| 11 | −63.2907 | 1.500 | 1.77250 | 49.63 | 0.5508 |
| 12 | −264.1072 | (Variable) | | | |
| 13 | 79.9982 | 5.382 | 1.43700 | 95.10 | 0.5326 |
| 14 | −193.1021 | 0.200 | | | |
| 15 | 78.6173 | 5.052 | 1.49700 | 81.61 | 0.5386 |
| 16 | −278.0686 | 0.200 | | | |
| 17 | 61.2944 | 8.872 | 1.49700 | 81.61 | 0.5386 |
| 18 | −60.7345 | 1.300 | 1.83481 | 42.72 | 0.5650 |
| 19 | 117.9451 | 2.700 | | | |
| 20 (Aperture Stop) | ∞ | 18.024 | | | |
| 21 | 163.3512 | 1.200 | 1.83400 | 37.16 | 0.5776 |
| 22 | 40.5008 | 8.022 | 1.51823 | 58.90 | 0.5457 |
| 23 | −84.0400 | 0.200 | | | |
| 24 | 78.6064 | 3.008 | 1.83481 | 42.72 | 0.5650 |
| 25 | 1019.6835 | (Variable) | | | |
| 26 | −288.7482 | 2.342 | 1.80518 | 25.46 | 0.6156 |
| 27 | −60.1020 | 4.557 | | | |
| 28 | −49.2539 | 1.000 | 1.77250 | 49.60 | 0.5520 |
| 29 | 42.3947 | (Variable) | | | |
| 30 | −45.0423 | 1.400 | 1.75211 | 25.05 | 0.6190 |
| 31 | −62.7141 | 0.200 | | | |
| 32 | 76.8156 | 3.984 | 1.83481 | 42.72 | 0.5650 |
| 33 | −47317.2031 | 39.493 | | | |
| Image Plane | ∞ | | | | |

Various Data
Zoom Ratio 4.047

| | Wide | Middle | Tele |
|---|---|---|---|
| Focal Length | 71.997 | 136.486 | 291.389 |
| Fno: | 4.120 | 4.120 | 4.120 |
| Half Angle of View (°) | 16.725 | 9.007 | 4.246 |
| Image Height | 21.635 | 21.635 | 21.635 |
| Overall lens length | 276.801 | 306.083 | 332.801 |
| BF | 39.493 | 58.857 | 64.844 |
| d 5 | 2.000 | 49.361 | 107.654 |
| d12 | 82.955 | 43.367 | 1.534 |
| d25 | 3.802 | 5.786 | 15.562 |
| d29 | 21.532 | 21.691 | 16.186 |
| d33 | 39.493 | 58.857 | 64.844 |

Zoom Lens Unit Data

| Unit | Starting Surface | Focal Length |
|---|---|---|
| 1 | 1 | 357.575 |
| 2 | 6 | −59.668 |
| 3 | 13 | 53.274 |
| 4 | 26 | −45.937 |
| 5 | 30 | 153.963 |

### Numerical Example 4

UNIT: mm
Surface Data

| Surface No. | r | d | nd | νd | θgF |
|---|---|---|---|---|---|
| 1 | 509.4253 | 5.145 | 1.55397 | 71.76 | 0.5389 |
| 2 | 1908.1748 | 0.500 | | | |
| 3 | 172.6878 | 14.918 | 1.43387 | 95.10 | 0.5373 |
| 4 | −6542.9443 | 79.356 | | | |
| 5 | 151.3594 | 7.360 | 1.43387 | 95.10 | 0.5373 |
| 6 | 1005.1306 | 1.834 | | | |
| 7 | −1171.2363 | 2.500 | 1.65412 | 39.68 | 0.5737 |
| 8 | 185.1693 | (Variable) | | | |
| 9 | 390.5571 | 2.000 | 1.75500 | 52.32 | 0.5474 |
| 10 | 126.1889 | 8.294 | | | |
| 11 | −115.1194 | 2.000 | 1.45860 | 90.19 | 0.5354 |
| 12 | 256.0979 | (Variable) | | | |
| 13 | 337.6115 | 2.846 | 1.94594 | 17.98 | 0.6546 |
| 14 | 1629.6846 | (Variable) | | | |
| 15 | 453.0790 | 10.195 | 1.43875 | 94.66 | 0.5340 |
| 16 | −135.6192 | 0.300 | | | |
| 17 | 202.0520 | 8.211 | 1.43875 | 94.66 | 0.5340 |
| 18 | −356.3936 | 0.300 | | | |
| 19 | 112.1278 | 13.346 | 1.43875 | 94.66 | 0.5340 |
| 20 | −167.8601 | 1.800 | 1.88300 | 40.76 | 0.5667 |
| 21 | 351.9034 | (Variable) | | | |
| 22 | 102.2878 | 8.157 | 1.43875 | 94.66 | 0.5340 |
| 23 | −848.5635 | (Variable) | | | |
| 24 (Aperture Stop) | ∞ | (Variable) | | | |
| 25 | 236.4199 | 2.191 | 1.86966 | 20.02 | 0.6434 |
| 26 | 648.7493 | 1.200 | 1.83481 | 42.74 | 0.5648 |
| 27 | 63.6631 | (Variable) | | | |
| 28 | 56.2840 | 6.407 | 1.58313 | 59.38 | 0.5434 |
| 29 | −150.1497 | 1.400 | 1.98612 | 16.48 | 0.6657 |
| 30 | 512.0374 | 1.816 | | | |
| 31 | −4546.1831 | 4.028 | 1.72047 | 34.71 | 0.5834 |
| 32 | −67.7594 | 1.200 | 1.43875 | 94.66 | 0.5340 |
| 33 | 40.8618 | 5.154 | | | |
| 34 | −81.0754 | 1.200 | 1.61800 | 63.40 | 0.5395 |
| 35 | 151.7764 | 3.690 | | | |
| 36 | 155.9681 | 3.892 | 1.89286 | 20.36 | 0.6393 |
| 37 | −89.4509 | 1.793 | | | |
| 38 | 846.1126 | 6.168 | 1.51680 | 64.20 | 0.5342 |
| 39 | −37.8113 | 1.500 | 1.69350 | 53.21 | 0.5473 |
| 40 | −83.0137 | 8.168 | | | |
| 41 | −273.1606 | 1.495 | 1.98612 | 16.48 | 0.6657 |
| 42 | 962.3575 | 3.565 | | | |
| 43 | −62.5689 | 1.489 | 1.85540 | 36.56 | 0.5782 |
| 44 | 2447.8470 | (Variable) | | | |
| 45 | 211.7513 | 6.420 | 1.67790 | 50.72 | 0.5557 |
| 46 | −56.4512 | (Variable) | | | |
| 47 | −65.0196 | 1.500 | 1.43875 | 94.66 | 0.5340 |
| 48 | −161.4072 | 47.957 | | | |
| Image Plane | ∞ | | | | |

Various Data
Zoom Ratio 1.904

| | Wide | Middle | Tele |
|---|---|---|---|
| Focal Length | 305.975 | 400.455 | 582.520 |
| Fno: | 2.900 | 3.300 | 4.600 |
| Half Angle of View (°) | 4.045 | 3.092 | 2.127 |
| Image Height | 21.635 | 21.635 | 21.635 |
| Overall lens length | 475.001 | 475.001 | 475.001 |
| BF | 47.957 | 47.957 | 47.957 |
| d 8 | 30.113 | 61.786 | 109.903 |
| d12 | 3.056 | 2.446 | 2.230 |
| d14 | 82.767 | 51.705 | 3.803 |
| d21 | 17.440 | 5.739 | 16.238 |
| d23 | 4.813 | 16.515 | 6.016 |
| d24 | 23.683 | 10.524 | 3.768 |
| d27 | 18.180 | 31.340 | 38.095 |
| d44 | 6.384 | 7.913 | 10.725 |
| d46 | 7.269 | 5.740 | 2.928 |

Zoom Lens Unit Data

| Unit | Starting Surface | Focal Length |
|---|---|---|
| 1 | 1 | 416.444 |
| 2 | 9 | −99.882 |
| 3 | 13 | 449.682 |
| 4 | 15 | 145.221 |
| 5 | 22 | 208.601 |
| 6 | 24 | ∞ |
| 7 | 25 | −106.379 |
| 8 | 28 | −128.199 |
| 9 | 45 | 66.388 |
| 10 | 47 | −249.342 |

Focus 23-24 Surfaces/35-38 Surfaces

| | Wide | Middle | Tele |
|---|---|---|---|
| INF | 0/0 | 0/0 | 0/0 |
| 10 m | 2.633/−1.267 | 4.081/−1.877 | 8.230/−3.552 |
| 5 m | 5.386/−2.429 | 8.377/−3.607 | 17.333/−6.404 |

### Numerical Example 5

UNIT: mm
Surface Data

| Surface No. | r | d | nd | νd | θgF |
|---|---|---|---|---|---|
| 1* | 233.5210 | 14.201 | 1.59349 | 67.00 | 0.5361 |
| 2 | −3860.7690 | 75.218 | | | |
| 3 | 167.5081 | 9.741 | 1.43387 | 95.10 | 0.5373 |
| 4 | 1366.7274 | 2.895 | | | |
| 5 | −907.6191 | 2.500 | 1.61340 | 44.27 | 0.5633 |
| 6 | 134.9541 | 10.172 | 1.43387 | 95.10 | 0.5373 |
| 7 | 733.9326 | (Variable) | | | |
| 8 | 418.4886 | 2.923 | 1.98612 | 16.48 | 0.6657 |
| 9 | 2855.5393 | 1.800 | 1.51680 | 64.20 | 0.5342 |
| 10 | 91.7731 | (Variable) | | | |
| 11 | −158.0234 | 1.800 | 1.75500 | 52.32 | 0.5474 |
| 12 | −1095.0250 | (Variable) | | | |
| 13 | 274.5113 | 9.678 | 1.43387 | 95.10 | 0.5373 |
| 14 | −157.2093 | 0.300 | | | |
| 15 | 147.8952 | 8.122 | 1.43387 | 95.10 | 0.5373 |
| 16 | −581.1844 | 0.300 | | | |
| 17 | 105.1297 | 12.023 | 1.43875 | 94.66 | 0.5340 |
| 18 | −187.0741 | 1.500 | 1.85150 | 40.78 | 0.5695 |
| 19 | 289.7811 | (Variable) | | | |
| 20 | 123.0396 | 5.946 | 1.49700 | 81.54 | 0.5375 |
| 21 | −2854.4014 | (Variable) | | | |
| 22 (Aperture Stop) | ∞ | (Variable) | | | |
| 23 | 613.1779 | 1.000 | 1.77250 | 49.60 | 0.5520 |
| 24 | 56.2042 | (Variable) | | | |
| 25 | 53.9825 | 1.000 | 1.89286 | 20.36 | 0.6393 |
| 26 | 37.6134 | 7.374 | 1.6134 | 44.27 | 0.5633 |
| 27 | −207.9132 | 0.981 | | | |
| 28 | 1552.5249 | 4.375 | 1.66565 | 35.64 | 0.5824 |
| 29 | −58.2642 | 1.200 | 1.55200 | 70.70 | 0.5421 |
| 30 | 47.9290 | 3.954 | | | |
| 31 | −144.3128 | 1.200 | 1.49700 | 81.54 | 0.5375 |
| 32 | 59.0492 | 2.499 | | | |
| 33 | 57.9347 | 6.233 | 1.58144 | 40.75 | 0.5774 |
| 34 | −94.1465 | (Variable) | | | |
| 35 | 220.2090 | 1.400 | 1.49700 | 81.54 | 0.5375 |
| 36 | 66.0540 | 7.287 | | | |
| 37 | −38.9405 | 1.400 | 1.75211 | 25.05 | 0.6190 |
| 38 | −45.3811 | (Variable) | | | |
| 39 | 53.4770 | 3.715 | 1.54814 | 45.79 | 0.5686 |
| 40 | 112.3255 | 6.030 | | | |
| 41 | −77.1110 | 1.500 | 1.49700 | 81.54 | 0.5375 |
| 42 | −105.0245 | 39.500 | | | |
| Image Plane | ∞ | | | | |

ASPHERIC DATA
1st Surface
K = 0.00000e+00 A 4 = 7.18492e−10 A 6 = 2.58156e−14 A 8 = 1.34636e−18

Various Data
Zoom Ratio 1.424

| | Wide | Middle | Tele |
|---|---|---|---|
| Focal Length | 409.422 | 505.057 | 582.860 |
| Fno: | 2.880 | 3.553 | 4.100 |
| Half Angle of View (°) | 3.025 | 2.453 | 2.126 |
| Image Height | 21.635 | 21.635 | 21.635 |
| Overall lens length | 475.002 | 475.002 | 475.002 |
| BF | 39.500 | 39.500 | 39.500 |
| d 7 | 78.590 | 105.041 | 124.799 |
| d10 | 13.095 | 14.557 | 15.911 |
| d12 | 51.821 | 23.907 | 2.796 |
| d19 | 14.645 | 11.584 | 15.115 |
| d21 | 4.855 | 7.917 | 4.386 |
| d22 | 21.855 | 11.025 | 3.911 |
| d24 | 19.450 | 30.279 | 37.393 |
| d34 | 6.280 | 4.664 | 1.976 |
| d38 | 14.644 | 16.260 | 18.948 |

Zoom Lens Unit Data

| Unit | Starting Surface | Focal Length |
|---|---|---|
| 1 | 1 | 385.915 |
| 2 | 8 | −293.729 |
| 3 | 11 | −244.803 |
| 4 | 13 | 132.759 |
| 5 | 20 | 237.492 |
| 6 | 22 | ∞ |
| 7 | 23 | −80.161 |
| 8 | 25 | 127.025 |
| 9 | 35 | −128.916 |
| 10 | 39 | 257.818 |

Focus 23-24 Surfaces/35-38 Surfaces

| | Wide | Middle | Tele |
|---|---|---|---|
| INF | 0/0 | 0/0 | 0/0 |
| 10 m | 4.312/1.809 | 6.062/2.617 | 7.603/3.365 |
| 5 m | 8.687/3.911 | 12.273/5.837 | 15.524/7.739 |

### Numerical Example 6

UNIT: mm
Surface Data

| Surface No. | r | d | nd | νd | θgF |
|---|---|---|---|---|---|
| 1 | 377.2064 | 4.992 | 1.55200 | 70.70 | 0.5421 |
| 2 | −308.8554 | 23.000 | | | |
| 3 | 102.6869 | 7.325 | 1.43700 | 95.10 | 0.5326 |
| 4 | −936.2210 | 1.800 | 1.80000 | 29.84 | 0.6017 |
| 5 | 358.7290 | (Variable) | | | |
| 6 | 491.2972 | 1.500 | 1.75500 | 52.32 | 0.5474 |
| 7 | 45.1559 | 6.008 | | | |
| 8 | −111.6719 | 1.500 | 1.49700 | 81.61 | 0.5386 |
| 9 | 45.1084 | 7.173 | 1.83400 | 37.34 | 0.5790 |
| 10 | −305.1587 | (Variable) | | | |
| 11 | −56.4522 | 1.500 | 1.59349 | 67.00 | 0.5361 |
| 12 | −506.1690 | (Variable) | | | |
| 13 | 115.0689 | 5.104 | 1.43700 | 95.10 | 0.5326 |
| 14 | −142.5829 | 0.200 | | | |
| 15 | 87.5168 | 4.562 | 1.49700 | 81.61 | 0.5386 |
| 16 | −379.5702 | 0.200 | | | |
| 17 | 57.4849 | 7.714 | 1.49700 | 81.61 | 0.5386 |
| 18 | −106.7474 | 1.300 | 1.83481 | 42.72 | 0.5650 |
| 19 | 129.8218 | 2.700 | | | |
| 20 (Aperture Stop) | ∞ | 12.700 | | | |
| 21 | 86.0973 | 1.200 | 1.74951 | 35.33 | 0.5818 |
| 22 | 32.4825 | 9.408 | 1.49700 | 81.61 | 0.5386 |
| 23 | −144.5309 | 0.200 | | | |
| 24 | 76.8445 | 2.747 | 1.85150 | 40.78 | 0.5695 |
| 25 | 265.6436 | (Variable) | | | |
| 26 | −137.4492 | 4.251 | 1.72047 | 34.71 | 0.5834 |
| 27 | −34.4731 | 1.000 | 1.59282 | 68.62 | 0.5458 |
| 28 | 42.2743 | (Variable) | | | |
| 29 | −40.2811 | 1.400 | 1.59270 | 35.45 | 0.5927 |
| 30 | −66.3445 | 0.200 | | | |
| 31 | 82.0262 | 4.137 | 1.71300 | 53.87 | 0.5459 |
| 32 | 5947.4920 | (Variable) | | | |
| Image Plane | ∞ | | | | |

Various Data
Zoom Ratio 2.886

| | Wide | Middle | Tele |
|---|---|---|---|
| Focal Length | 101.052 | 149.599 | 291.652 |
| Fno | 4.120 | 4.120 | 4.120 |
| Half Angle of View (°) | 12.084 | 8.229 | 4.242 |
| Image Height | 21.635 | 21.635 | 21.635 |
| Overall lens length | 279.187 | 298.229 | 308.962 |
| BF | 39.496 | 46.458 | 52.523 |
| d 5 | 15.457 | 41.395 | 71.518 |
| d10 | 4.243 | 5.452 | 5.454 |
| d12 | 50.522 | 34.089 | 1.454 |
| d25 | 4.624 | 5.350 | 8.335 |
| d28 | 51.023 | 51.663 | 55.855 |
| d32 | 39.496 | 46.458 | 52.523 |

Zoom Lens Unit Data

| Unit | Starting Surface | Focal Length |
|---|---|---|
| 1 | 1 | 205.720 |
| 2 | 6 — | 116.803 |
| 3 | 11 | −107.192 |
| 4 | 13 | 49.219 |
| 5 | 26 | −63.658 |
| 6 | 29 | 330.139 |

TABLE 1 below summarizes various values according to each numerical example.

TABLE 1

| | NUMERICAL EXAMPLE | | | | | |
|---|---|---|---|---|---|---|
| | 1 | 2 | 3 | 4 | 5 | 6 |
| fw | 409.335 | 306.239 | 71.997 | 305.975 | 409.422 | 101.052 |
| ft | 582.738 | 582.535 | 291.389 | 582.520 | 582.860 | 291.652 |
| f1 | 410.021 | 412.353 | 357.575 | 416.444 | 385.915 | 205.720 |
| f2 | −130.744 | −136.937 | −59.668 | −99.882 | −293.729 | −116.803 |
| f3 | 133.646 | 152.746 | 53.274 | 449.682 | −244.803 | −107.192 |
| f4 | 216.820 | 202.855 | −45.937 | 145.221 | 132.759 | 49.219 |
| f5 | −79.059 | −97.865 | 153.963 | 208.601 | 237.492 | −63.658 |
| f6 | 120.226 | −222.023 | | −106.379 | −80.161 | 330.139 |
| f7 | −135.543 | 77.826 | | −128.199 | 127.025 | |
| f8 | 326.087 | −241.489 | | 66.388 | −128.916 | |
| f9 | | | | −249.342 | 257.818 | |
| TDw | 435.502 | 433.216 | 237.309 | 427.044 | 435.501 | 239.691 |
| TDt | 435.502 | 433.216 | 267.957 | 427.044 | 435.501 | 256.439 |
| skw | 39.500 | 41.785 | 39.493 | 47.957 | 39.500 | 39.496 |
| skt | 39.500 | 41.785 | 64.844 | 47.957 | 39.500 | 52.523 |
| LDw | 475.002 | 475.001 | 276.801 | 475.001 | 475.002 | 279.187 |
| LDt | 475.002 | 475.001 | 332.801 | 475.001 | 475.002 | 308.962 |
| dsw | 156.583 | 168.619 | 108.762 | 167.749 | 152.877 | 132.387 |
| dst | 156.583 | 168.619 | 140.529 | 167.749 | 152.877 | 153.957 |
| β2w | −2.169 | −1.364 | −0.274 | −0.742 | 2.780 | −2.174 |
| β3w | −0.397 | −0.577 | −0.373 | 1.673 | −0.917 | 0.214 |
| β2t | −10.430 | −7.548 | −0.532 | −1.822 | 1.934 | 49.850 |
| β3t | −0.098 | −0.148 | −0.693 | 2.780 | −15.674 | −0.019 |
| fLA | 133.646 | 152.746 | 53.274 | 145.221 | 132.759 | 49.219 |
| fU | −130.744 | −136.937 | −59.668 | −130.677 | −130.149 | −50.585 |
| d1a | 79.136 | 79.751 | 18.200 | 79.356 | 75.218 | 23.000 |
| dUa | 10.005 | 8.588 | 6.013 | 8.294 | 15.911 | 6.008 |
| (1)dsw/Ldw | 0.330 | 0.355 | 0.393 | 0.353 | 0.322 | 0.474 |
| (2)nd1max | 1.65412 | 1.65412 | 1.78800 | 1.65412 | 1.61340 | 1.80000 |
| (3)d1a/dUa | 7.910 | 9.287 | 3.027 | 9.568 | 4.727 | 3.828 |
| (4)ndUv | 1.89286 | 1.94594 | 1.83400 | 1.94594 | 1.98612 | 1.83400 |
| (5)θgFUv | 0.6393 | 0.6546 | 0.5790 | 0.6546 | 0.6657 | 0.5790 |
| (6)νd1a | 74.943 | 75.410 | 63.151 | 75.410 | 75.367 | 65.214 |
| (7)βUt | −10.430 | −7.548 | −0.532 | −5.066 | −30.315 | −0.958 |
| (8)βUt/βUw | 4.808 | 5.534 | 1.943 | 4.081 | 11.889 | 2.057 |
| (9)f1/fLA | 3.068 | 2.700 | 6.712 | 2.868 | 2.907 | 4.180 |
| (10)fU/ft | −0.224 | −0.235 | −0.205 | −0.224 | −0.223 | −0.173 |
| (11)skt/ft | 0.068 | 0.072 | 0.223 | 0.082 | 0.068 | 0.180 |
| (12)f1/fU | −3.136 | −3.011 | −5.993 | −3.187 | −2.965 | −4.067 |

### Image Pickup Apparatus

Referring now to FIG. 13, a description will be given of a digital still camera (an image pickup apparatus) in which the zoom lens according to any one of the above examples is used as an image pickup optical system. In FIG. 13, reference numeral 10 denotes a camera body, reference numeral 11 denotes an image pickup optical system configured by the zoom lens according to any one of Examples 1 to 6. Reference numeral 12 denotes a solid-state image sensor (photoelectric conversion element) such as a CCD sensor or a CMOS sensor, which is built into the camera body and receives an optical image formed by the image pickup optical system 11 and photoelectrically converts it. The camera body 10 may be a so-called single-lens reflex camera with a quick turn mirror, or a so-called mirrorless camera without a quick turn mirror.

In this way, by applying the zoom lens according to each example to an image pickup apparatus such as a digital still camera, an image pickup apparatus with a compact lens can be obtained.

### Image Pickup System

An image pickup system (surveillance camera system) including the zoom lens according to each example and a control unit that controls the zoom lens may be configured. In this case, the control unit can control the zoom lens so that each lens unit moves as described above during zooming, focusing, and image stabilization. At this time, the control unit does not need to be configured integrally with the zoom lens, and may be configured separately from the zoom lens. For example, a control unit (a control apparatus) located far from a drive unit that drives each lens of the zoom lens may be equipped with a transmission unit that sends a control signal (command) to control the zoom lens. According to such a control unit, the zoom lens can be controlled remotely.

Further, a configuration may be adopted in which the control unit is provided with an operation section such as a controller or a button for remotely controlling the zoom lens, so that the zoom lens is controlled in accordance with user's input to the operation section. For example, an enlargement button and a reduction button may be provided as the operation section. In this case, the control unit may be configured to send a signal to the drive unit of the zoom lens so that when the user presses the enlargement button, the magnification of the zoom lens increases, and when the user presses the reduction button, the magnification of the zoom lens decreases.

Further, the image pickup system may include a display unit such as a liquid crystal panel that displays information regarding zooming (movement state) of the zoom lens. The information regarding zooming of the zoom lens is, for example, the zoom magnification (zoom state) and the movement amount (movement state) of each lens unit. In this case, the user can remotely operate the zoom lens via the operation section while viewing the information regarding zooming of the zoom lens shown on the display unit. At this time, the display unit and the operation section may be integrated, for example, by employing a touch panel or the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

According to the present disclosure, it is possible to provide a zoom lens that is small and has a large aperture and yet provides high optical performance.

This application claims the benefit of Japanese Patent Application No. 2023-005206, filed on Jan. 17, 2023, which is hereby incorporated by reference herein in its entirety.

What is claimed is:

1. A zoom lens comprising, in order from an object side to an image side:
a first lens unit having a positive refractive power;
a front group including one or two lens unit and having a negative refractive power as a whole; and
a rear group including an aperture stop and one or more lens unit,
wherein each distance between adjacent lens units changes during zooming,
wherein the first lens unit is fixed relative to an image plane during focusing,
wherein the first lens unit includes a positive lens disposed closest to an object,
wherein at least four lens units move during zooming from a wide-angle end to a telephoto end,
wherein at the telephoto end, a combined refractive power from the positive lens to a lens disposed closest to an image in the front group is negative, and
wherein the following inequalities are satisfied:
$$0.1 < dsw / Ldw < 0.5 ,$$
$$1.45 < nd 1 max \leq 1.8 , and$$
$$3 < d 1 a / dUa < 300 ,$$
where dsw is a distance on an optical axis from the aperture stop to the image plane at the wide-angle end, Ldw is a total length of the zoom lens at the wide-angle end, nd1max is a maximum refractive index of lenses included in the first lens unit, d1a is a maximum value of air intervals in the first lens unit in an entire zoom range, and dUa is a maximum value of air intervals in the front group in the entire zoom range.

2. The zoom lens according to claim 1, wherein the following inequality is satisfied:
$$1.75 < ndUv < 2.4 ,$$
where ndUv is a refractive index of a lens made of a material having a maximum refractive index among lenses included in the front group.

3. The zoom lens according to claim 1, wherein the following inequality is satisfied:
$$0.56 < θ gFUv < 0.68 ,$$
where θgFUv is a partial dispersion ratio of a lens made of a material having a maximum refractive index among lenses included in the front group.

4. The zoom lens according to claim 1, wherein the following inequality is satisfied:
$$56 < vd 1 a < 100 ,$$
where νd1a is an average value of Abbe numbers in a d-line of lenses included in the first lens unit.

5. The zoom lens according to claim 1, wherein the following inequality is satisfied:
$$- 35. < β Ut < - 0.45 ,$$
where βUt is a lateral magnification of the front group at the telephoto end.

6. The zoom lens according to claim 1, wherein the following inequality is satisfied:
$$1.7 < β Ut / β Uw < 20. ,$$
where βUt is a lateral magnification of the front group at the telephoto end, and βUw is a lateral magnification of the front group at the wide-angle end.

7. The zoom lens according to claim 1, wherein the following inequality is satisfied:
$$2.4 < f 1 / fLA < 10. ,$$
where f1 is a focal length of the first lens unit, and fLA is a focal length of a lens unit disposed closest to the object in the rear group.

8. The zoom lens according to claim 1, wherein the following inequality is satisfied:
$$- 0.35 < fU / ft < - 0.05 ,$$
where fU is a focal length of the front group at the telephoto end, and ft is a focal length of the zoom lens at the telephoto end.

9. The zoom lens according to claim 1, wherein the following inequality is satisfied:
$$0.01 < skt / ft < 0.35 ,$$
where skt is a back focus at the telephoto end, and ft is a focal length of the zoom lens at the telephoto end.

10. The zoom lens according to claim 1, wherein the following inequality is satisfied:
$$- 9. < f 1 / fU < - 1.6 ,$$
Where f1 is a focal length of the first lens unit, and fU is a focal length of the front group at the telephoto end.

11. The zoom lens according to claim 1, wherein a lens unit disposed closest to the object in the rear group is fixed relative to the image plane during zooming.

12. The zoom lens according to claim 1, wherein the first lens unit is composed of four or less lenses.

13. The zoom lens according to claim 1, wherein the first lens unit is composed of one negative lens and two or three positive lenses.

14. The zoom lens according to claim 1, wherein the front group is composed of three or four spherical lenses including at least one positive lens.

15. The zoom lens according to claim 1, wherein a lens unit disposed closest to the image in the zoom lens is fixed relative to the image plane during zooming.

16. The zoom lens according to claim 1, wherein a lens disposed closest to the image in the zoom lens is a lens having a convex shape on the image side.

17. The zoom lens according to claim 1, wherein the aperture stop is disposed closer to the image than a lens unit disposed closest to the object in the rear group.

18. The zoom lens according to claim 1, wherein a lens disposed adjacent to the image side of the aperture stop is composed of an element having a convex shape on the object side.

19. The zoom lens according to claim 1, wherein the zoom lens includes the first lens unit, a second lens unit having a negative refractive power, and the rear group, which are arranged in order from the object side to the image side.

20. The zoom lens according to claim 19, wherein the rear group is composed of a third lens unit having a positive refractive power, a fourth lens unit having a positive refractive power, a fifth lens unit having a negative refractive power, a sixth lens unit having a positive refractive power, a seventh lens unit having a negative refractive power, and an eighth lens unit having a positive refractive power.

21. The zoom lens according to claim 19, wherein the rear group is composed of a third lens unit having a positive refractive power, a fourth lens unit having a positive refractive power, a fifth lens unit having a negative refractive power, a sixth lens unit having a negative refractive power, a seventh lens unit having a positive refractive power, and an eighth lens unit having a negative refractive power.

22. The zoom lens according to claim 19, wherein the rear group is composed of a third lens unit having a positive refractive power, a fourth lens unit having a negative refractive power, and a fifth lens unit having a positive refractive power.

23. The zoom lens according to claim 1, wherein the zoom lens includes the first lens unit, a second lens unit having a negative refractive power, a third lens unit, and the rear group, which are arranged in order from the object side to the image side.

24. The zoom lens according to claim 23, wherein the rear group is composed of a fourth lens unit having a positive refractive power, a fifth lens unit having a positive refractive power, a sixth lens unit having a negative refractive power, a seventh lens unit having a negative refractive power, an eighth lens unit having a positive refractive power, and a ninth lens unit having a negative refractive power.

25. The zoom lens according to claim 23, wherein the rear group is composed of a fourth lens unit having a positive refractive power, a fifth lens unit having a positive refractive power, a sixth lens unit having a negative refractive power, a seventh lens unit having a positive refractive power, an eighth lens unit having a negative refractive power, and a ninth lens unit having a positive refractive power.

26. The zoom lens according to claim 23, wherein the rear group is composed of a fourth lens unit having a positive refractive power, a fifth lens unit having a negative refractive power, and a sixth lens unit having a positive refractive power.

27. An image pickup apparatus comprising:
a zoom lens according to claim 1; and
an image sensor configures to capture an image formed by the zoom lens,
wherein the zoom lens comprising, in order from an object side to an image side:
a first lens unit having a positive refractive power;
a front group including one or two lens unit and having a negative refractive power as a whole; and
a rear group including an aperture stop and one or more lens unit,
wherein each distance between adjacent lens units changes during zooming,
wherein the first lens unit is fixed relative to an image plane during focusing,
wherein the first lens unit includes a positive lens disposed closest to an object,
wherein at least four lens units move during zooming from a wide-angle end to a telephoto end,
wherein at the telephoto end, a combined refractive power from the positive lens to a lens disposed closest to an image in the front group is negative, and
wherein the following inequalities are satisfied:
$$0.1 < dsw / Ldw < 0.5 ,$$
$$1.45 < nd 1 max \leq 1.8 , and$$
$$3 < d 1 a / dUa < 300 ,$$
where dsw is a distance on an optical axis from the aperture stop to the image plane at the wide-angle end, Ldw is a total length of the zoom lens at the wide-angle end, nd1max is a maximum refractive index of lenses included in the first lens unit, d1a is a maximum value of air intervals in the first lens unit in an entire zoom range, and dUa is a maximum value of air intervals in the front group in the entire zoom range.
